(19) United States
(12) Patent Application Publication
(10) Pub. No.: US 2026/0365364 A1
(43) Pub. Date: Nov. 19, 2026

(54) CONTINUOUS BOX BLANKS, BOXES AND METHODS OF FORMING THE SAME

(71) Applicant: Georgia-Pacific Corrugated LLC, Atlanta, GA (US)

(72) Inventors: Katherine Duenas Gayahan, Atlanta, GA (US); Andrew Geoffrey Halcomb, Johns Creek, GA (US); Devin Paul Bachurski, Norcross, GA (US)

(21) Appl. No.: 19/678,229

(22) Filed: May 15, 2026

Related U.S. Application Data
(60) Provisional application No. 63/807,068, filed on May 16, 2025.

(51) Int. Cl. B65D 5/42; B31B 50/26; B31B 50/62

(52) U.S. Cl. CPC B65D 5/4266; B31B 50/262; B31B 50/624; B65D 5/4279; B65D 2313/10

(57) ABSTRACT

Box blanks, boxes, and corresponding methods of forming the same are provided. The box blank comprises a plurality of sections each having a plurality of panels. Each of the plurality of sections are connected along a foldable section score line and each of the panels are connected along a foldable panel score line. A first pattern score is positioned along a first bottom panel, the first pattern score having one or more score lines separating the first bottom panel into at least three sections. A second pattern score is positioned along a third bottom panel, the second pattern score having one or more score lines separating the third bottom panel into at least three sections. The first bottom panel and the third bottom panel are pre-crushed to aid in folding of the first bottom panel and the third bottom panel.

### FIELD

Example embodiments of the present invention generally relate to paper-based box designs and corresponding methods of manufacturing and methods of forming the boxes.

### BACKGROUND

Box blanks may be formed of a web of material including corrugate, paperboard, or other materials. Box blanks often comprise various cuts, cut outs, perforations, scores and/or compressions that aid in folding thereof and/or erecting a box therefrom. A box may be assembled by a user and/or with a box maker (e.g., a case erector).

Various box designs provide benefits depending on their desired usage. Notably, however, current box designs include Regular Slotted Containers (RSC) which require a user to erect the box by closing four to eight flaps in the correct order and sealing the flaps with adhesive or other external tools in order to form the box. Furthermore, current box designs also require a cutting tool for the end user to open the erected box. These processes take time and are costly.

### BRIEF SUMMARY

Corrugated packaging is commonly used in e-commerce fulfillment and shipping applications, where boxes are used to protect and transport goods from distribution centers to end consumers. Regular Slotted Containers (RSC) are widely used in these applications due to their versatility and established manufacturing processes. However, these conventional box designs present several technical challenges during assembly and use. These designs typically require a user to erect the box by closing four to eight separate flaps in a specific order and sealing the flaps with adhesive tape or other external tools. The separation between adjacent flaps in conventional box blanks means that each flap operates independently, requiring individual manipulation and sequential closure. Additionally, conventional box designs often require cutting tools for the end user to open the erected box after sealing. These processes are time-consuming, increase labor costs, and introduce inefficiencies in packaging operations. Furthermore, conventional single-face corrugated boxes present additional challenges because the material lacks sufficient stiffness when the flutes run in the standard direction, making the box too flimsy to erect and causing the material to fold unpredictably rather than along intended score lines.

Single-face corrugated material also exhibits reduced scoring memory when score lines run parallel to the flute direction. Scoring memory refers to the tendency of a scored material to retain a fold or crease along a score line after the scoring operation. When the flutes extend in the same direction as the score lines, the single-face corrugated material may not retain sufficient scoring memory along those score lines when only scoring is applied. This characteristic of single-face material creates difficulties in achieving consistent, predictable folding behavior during box assembly, particularly for hand erecting operations where precise fold lines are needed to guide the user through the assembly process.

Example box blanks, boxes, and methods disclosed herein address these limitations by providing a continuous box blank structure with pattern scores that enable coordinated, interdependent folding of panels without separate flap manipulation or external closure tools. In some embodiments, the box blank comprises four sections, each having at least a body panel and a bottom panel connected along a portion of a first panel score line, with the sections connected to one another along section score lines. A glue flap is connected to either the first section or the fourth section along a fourth section score line, and the box blank is configured to be assembled into a formed box when the glue flap is connected to the opposing section. In some embodiments, adjacent panels are connected via weaknesses, creasing, scoring, or small perforations, with no cuts or separations between adjacent panels within the outer periphery of the box blank.

In some embodiments, a first pattern score positioned along the first bottom panel and a second pattern score positioned along the third bottom panel each have one or more score lines separating the respective panel into at least three sections. The first and third bottom panels with pattern scores may be pre-crushed to aid in folding. When assembled, the pattern scores enable the first bottom panel to fold towards the third bottom panel, causing the second and fourth bottom panels to fold on top to form the bottom portion. Pattern scores on selected panels include diagonal score lines that separate each panel into triangular-shaped sections, enabling sequential, coordinated folding. The pre-crushing weakens the material along score lines, enabling smoother folding and reducing resistance during box formation, which is particularly beneficial for hand erecting of single-face boxes.

In some embodiments, the box blank may be formed from single-face corrugated material with flutes oriented perpendicular to the section score lines and parallel to the panel score lines, providing sufficient structural rigidity to the body panels during hand erecting. Because single-face corrugated material exhibits reduced scoring memory when score lines run parallel to the flute direction, at least one of the panel score lines may include perforations to aid in folding. In some embodiments, extension portions with adhesive material may be connected to selected panels to enable tool-free closure, and tear strips may be positioned between extension portions and adjacent panels to allow tool-free opening. In some embodiments, a teardown feature comprising a tear strip with pre-scored weakened sections may extend vertically through one section, enabling breakdown of the assembled box for disposal without external tools. In some embodiments, flutes on certain sections may be offset from flutes on other sections, allowing sections to nest together in flat knocked-down tubular form. In some embodiments, folding of the pattern scores creates triangular protrusions in the interior of the formed box, which may aid in stabilizing and protecting items.

In an example embodiment a box blank for a box is provided. The box blank comprises a first section comprising at least a first body panel and a first bottom panel connected along a first portion of a first panel score line. The box blank further comprises a second section comprising at least a second body panel and a second bottom panel connected along a second portion of the first panel score line. The first section and the second section are connected along a first section score line. The box blank further comprises a third section comprising at least a third body panel and a third bottom panel connected along a third portion of the first panel score line. The second section and the third section are connected along a second section score line. The box blank further comprises a fourth section comprising at least a fourth body panel and a fourth bottom panel connected along a fourth portion of the first panel score line. The third section and the fourth section are connected along a third section score line. The box blank further a glue flap comprising at least a first glue flap panel connected to either the first section or the fourth section along a fourth section score line. Each portion of the first panel score line, the first section score line, the second section score line, the third section score line and the fourth section score line is foldable.

The box blank further comprises a first pattern score positioned along the first bottom panel, the first pattern score having one or more score lines separating the first bottom panel into at least three sections. The box blank further comprises a second pattern score positioned along the third bottom panel, the second pattern score having one or more score lines separating the third bottom panel into at least three sections. The first bottom panel with the first pattern score is pre-crushed to aid in folding of the first bottom panel, and the third bottom panel with the second pattern score is pre-crushed to aid in folding of the third bottom panel. The box blank is configured to be assembled into a formed box when the glue flap is connected to either the first section or the fourth section along the fourth section score line. When the box blank is assembled into the formed box, the first pattern score and the second pattern score enable folding such that the first bottom panel folds towards the third bottom panel, and the folding enables the second bottom panel and the fourth bottom panel to fold on top of the first bottom panel and the third bottom panel to form a bottom portion of the formed box.

In some embodiments, the first section further comprises a first top panel connected to the first body panel along a first portion of a second panel score line. The second section further comprises a second top panel connected to the second body panel along a second portion of the second panel score line. The first top panel and the second top panel are also connected along the first section score line. The third section further comprises a third top panel connected to the third body panel along a third portion of the second panel score line. The second top panel and the third top panel are also connected along the second section score line. The fourth section further comprises a fourth top panel connected to the fourth body panel along a fourth portion of the second panel score line. The third top panel and the fourth top panel are also connected along the third section score line. Each portion of the second panel score line is foldable.

In some embodiments, adjacent panels of the box blank are not separated from each other. In some embodiments, the box blank includes a first outer edge, a second outer edge, a third outer edge, and a fourth outer edge defining an outer periphery of the box blank, and there are no cuts between adjacent panels of the box blank. In some embodiments, the one or more score lines include two diagonal score lines, and the one or more score lines are configured to create at least a first triangular-shaped section, a second triangular-shaped section and a third triangular-shaped section along each of the first bottom panel and the third bottom panel.

In some embodiments, when the box blank is assembled into the formed box the first pattern score and the second pattern score enable folding such that the second triangular-shaped section is folded first. When the box blank is assembled into the formed box the first triangular-shaped section and the third triangular-shaped section fold over the second triangular-shaped section. When the box blank is assembled into the formed box the first triangular-shaped section and the third triangular-shaped section cause the second bottom panel and the fourth bottom panel to fold on top of the first bottom panel and the third bottom panel to form the bottom portion of the formed box.

In some embodiments, the box blank may further comprise at least two extension portions connected to the second top panel and the second bottom panel of the second section or the fourth top panel and the fourth bottom panel of the fourth section. In some embodiments, a first extension portion of the at least two extension portions and the second or the fourth bottom panel are connected along a first extension portion score line, and a second extension portion of the at least two extension portions and the second or the fourth top panel are connected along a second extension portion score line. In some embodiments, each of the at least two extension portions include adhesive material to aid in assembling the box. In some embodiments, the box blank may further comprise one or more tear strips positioned between one or more of the extension portions and the second top panel of the second section, one or more tear strips comprising pre-scored weakened sections positioned between one or more of the extension portions and the second top panel of the second section, the second bottom panel of the second section, the fourth top panel of the fourth section or the fourth bottom panel of the fourth section.

In some embodiments, the box is a single-face corrugated box, and wherein the box includes a plurality of flutes positioned on an interior surface of the box perpendicular to the first, the second, the third, and the fourth section score lines and parallel to the first and the second panel score lines. In some embodiments, placement of the plurality of flutes positioned on the first section and the fourth section of the box are offset by a distance from the plurality of flutes positioned on the second section and the third section of the box. In some embodiments, the offset placement of the plurality of flutes allows the first section and the fourth section of the box to nest into the second section and the third section of the box when the box is in a flat knocked-down tubular form.

In some embodiments, the formed box includes one or more triangular protrusions positioned in an interior of the formed box created from the folding of the first pattern score and the second pattern score. In some embodiments, the one or more triangular protrusions aid in stabilizing an item placed inside the formed box. In some embodiments, the one or more triangular protrusions aid in protecting an item placed inside the formed box from damage. In some embodiments, the one or more triangular protrusions aid in resistance of movement of an item placed inside the formed box. In some embodiments, at least one of the first portion, the second portion, the third portion, or the fourth portion of the first panel score line includes one or more perforations. In some embodiments, the one or more perforations aid in folding of the box blank along the first panel score line.

In another example embodiment a box blank for a box is provided. The box blank comprises a first section comprising at least a first body panel, a first bottom panel connected along a first portion of a first panel score line, and a first top panel connected to the first body panel along a first portion of a second panel score line. The box blank further comprises a second section comprising at least a second body panel, a second bottom panel connected along a second portion of the first panel score line, and a second top panel connected to the second body panel along a second portion of the second panel score line. The first section and the second section are connected along a first section score line. The box blank further comprises a third section comprising at least a third body panel, a third bottom panel connected along a third portion of the first panel score line, and a third top panel connected to the third body panel along a third portion of the second panel score line. The second section and the third section are connected along a second section score line. The box blank further comprises a fourth section comprising at least a fourth body panel, a fourth bottom panel connected along a fourth portion of the first panel score line, and a fourth top panel connected to the fourth body panel along a fourth portion of the second panel score line. The third section and the fourth section are connected along a third section score line.

The box blank further comprises a glue flap comprising at least a first glue flap panel connected to either the first section or the fourth section along a fourth section score line. The box blank further comprises one or more extension portions connected to the second top panel, the second bottom panel, the fourth top panel or the fourth bottom panel of the box blank along an extension portion score line. Each portion of the first panel score line, each portion of the second panel score line, the first section score line, the second section score line, the third section score line and the fourth section score line are foldable. The box blank further comprises a first pattern score positioned along the first bottom panel, the first pattern score having one or more score lines separating the first bottom panel into at least three sections. The box blank further comprises a second pattern score positioned along the third bottom panel, the second pattern score having one or more score lines separating the third bottom panel into at least three sections. The box blank further comprises a third pattern score positioned along the first top panel, the third pattern score having one or more score lines separating the first top panel into at least three sections. The box blank further comprises a fourth pattern score positioned along the third top panel, the fourth pattern score having one or more score lines separating the third top panel into at least three sections. The first bottom panel with the first pattern score is pre-crushed to aid in folding of the first bottom panel. The third bottom panel with the second pattern score is pre-crushed to aid in folding of the third bottom panel. The first top panel with the third pattern score is pre-crushed to aid in folding of the first top panel. Th third top panel with the fourth pattern score is pre-crushed to aid in folding of the third top panel.

The box blank is configured to be assembled into a formed box when the glue flap is connected to either the first section or the fourth section along the fourth section score line. When the box blank is assembled into the formed box, the first pattern score and the second pattern score enable folding such that the first bottom panel folds towards the third bottom panel, and the folding enables the second bottom panel and the fourth bottom panel to fold on top of the first bottom panel and the third bottom panel to form a bottom portion of the formed box. When the box blank is assembled into the formed box, the third pattern score and the fourth pattern score enable folding such that the first top panel folds towards the third top panel, and the folding enables the second top panel and the fourth top panel to fold on top of the first top panel and the third top panel to form a top portion of the formed box. The one or more extension portions include adhesive material to aid in closing and sealing the formed box.

In some embodiments, at least one of the first panel score line or the second panel score line includes one or more perforations. In some embodiments, the one or more perforations aid in folding of the box blank along at least one of the first panel score line or the second panel score line. In some embodiments, the box is a single-face corrugated box. In some embodiments, the box includes a plurality of flutes positioned on an interior surface of the box perpendicular to the first, the second, the third, and the fourth section score lines and parallel to the first and the second panel score lines.

In some embodiments, the box blank further comprises a teardown feature disposed on, and substantially extending vertically through, the first section, the second section, the third section or the fourth section of the box blank. In some embodiments, once the box is assembled, the teardown feature enables the breaking down of the formed box. In some embodiments, the teardown feature includes a tear strip comprising pre-scored weakened sections extending vertically along the first section, the second section, the third section or the fourth section of the box blank. In some embodiments, the teardown feature includes a pull tab located at one end of the tear strip. In some embodiments, pulling the pull tab from the formed box engages the tear strip to cut through the first section, the second section, the third section or the fourth section of the formed box along the pre-scored weakened sections of the tear strip, enabling the breakdown of the formed box. In some embodiments, once the tear strip is pulled from the box, the box assumes a flattened structure to aid in disposal.

In another example embodiment a method of forming a box is provided. The method comprises providing a blank made from a single-face corrugated material having a plurality of flutes positioned on one side of the blank. The blank comprises a first section comprising at least a first body panel and a first bottom panel connected along a first portion of a first panel score line. The blank further comprises a second section comprising at least a second body panel and a second bottom panel connected along a second portion of the first panel score line. The first section and the second section are connected along a first section score line. The blank further comprises a third section comprising at least a third body panel and a third bottom panel connected along a third portion of the first panel score line. The second section and the third section are connected along a second section score line. The blank further comprises a fourth section comprising at least a fourth body panel and a fourth bottom panel connected along a fourth portion of the first panel score line. The third section and the fourth section are connected along a third section score line. The blank further comprises a glue flap comprising at least a first glue flap panel connected to either the first section or the fourth section along a fourth section score line.

The plurality of flutes each define a longitudinal axis that extends perpendicularly to the first section score line, the second section score line, the third section score line, and the fourth section score line and parallel to the first panel score line. Each portion of the first panel score line, the first section score line, the second section score line, the third section score line and the fourth section score line is foldable. The blank further comprises a first pattern score positioned along the first bottom panel, the first pattern score having one or more score lines separating the first bottom panel into at least three sections. The blank further comprises a second pattern score positioned along the third bottom panel, the second pattern score having one or more score lines separating the third bottom panel into at least three sections. The first bottom panel with the first pattern score is pre-crushed to aid in folding of the first bottom panel. The third bottom panel with the second pattern score is pre-crushed to aid in folding of the third bottom panel. The method further comprises adhering the glue flap to the first section or to the fourth section to form a four walled structure. When the box blank is assembled into the formed box, the first pattern score and the second pattern score enable folding such that the first bottom panel folds towards the third bottom panel, and the folding enables the second bottom panel and the fourth bottom panel to fold on top of the first bottom panel and the third bottom panel to form a bottom portion of the formed box.

In some embodiments, the blank further comprising at least one extension portion connected to the second bottom panel of the second section or the fourth bottom panel of the fourth section. In some embodiments, the at least one extension portion includes an adhesive material. In some embodiments, the method further comprises folding the first bottom panel towards a center of the four walled structure. In some embodiments, the method further comprises folding the third bottom panel towards the center of the four walled structure such that a portion of the first bottom panel is in face-to-face contact with a portion of the third bottom panel. In some embodiments, the method further comprises causing adherence of the at least one extension portion to a receiving portion of the second bottom panel or the fourth bottom panel to assemble the formed box.

### BRIEF DESCRIPTION OF THE DRAWINGS

Reference will now be made to the accompanying drawings, which are not necessarily drawn to scale, and wherein:

FIG. 1 illustrates an example box blank, in accordance with some embodiments discussed herein;

FIG. 2A illustrates an example box blank defining sections of the box blank, in accordance with some embodiments discussed herein;

FIG. 2B illustrates features of the example box blank shown in FIG. 2A, in accordance with some embodiments discussed herein;

FIG. 3 illustrates features of the example box blank shown in FIG. 1, in accordance with some embodiments discussed herein;

FIGS. 4A-4B illustrate perspective views of a tubular knocked-down box of the example box blank shown in FIG. 1, in accordance with some embodiments discussed herein;

FIG. 5A illustrates a side view of a partially assembled box, in accordance with some embodiments discussed herein;

FIG. 5B is a close-up perspective view of a bottom portion of the partially assembled box shown in FIG. 5A, in accordance with some embodiments discussed herein;

FIG. 6 illustrates a perspective view of the partially assembled box shown in FIG. 5A, where arrows indicate a folding direction of a plurality of panels of the bottom portion of the partially assembled box, in accordance with some embodiments discussed herein;

FIG. 7 illustrates a perspective view of an interior surface of the partially assembled box shown in FIG. 6 after folding of the plurality of panels of the bottom portion of the partially assembled box, in accordance with some embodiments discussed herein;

FIG. 8 illustrates a close-up perspective view of one or more protrusions formed in the interior surface of the partially assembled box, in accordance with some embodiments discussed herein;

FIG. 9 illustrates a perspective view of an assembled box, where a plurality of panels of a top portion of the partially assembled box of FIG. 7 is folded and attached to form the assembled box, in accordance with some embodiments discussed herein;

FIG. 10A illustrates a perspective view of an assembled box having one or more tear strips, in accordance with some embodiments discussed herein;

FIG. 10B illustrates a perspective view depicting opening of the example box of FIG. 10A, in accordance with some embodiments discussed herein;

FIG. 11 illustrates a plurality of flutes, positioned in the interior surface of the tubular knocked-down box of FIGS. 4A-4B, the plurality of flutes allowing one or more sections of the box to nest into one or more other sections of the box when the box is in the tubular knocked-down form, in accordance with some embodiments discussed herein;

FIG. 12 illustrates an example box blank including a teardown feature and defining sections of the box blank, in accordance with some embodiments discussed herein;

FIG. 13 illustrates a perspective view of a tubular knocked-down box of another example box blank with a teardown feature, in accordance with some embodiments discussed herein;

FIG. 14 illustrates a perspective view of an example assembled box having a teardown feature positioned on the assembled box to aid in breaking down of the assembled box, in accordance with some embodiments discussed herein;

FIG. 15 illustrates a perspective view of another example assembled box having a teardown feature positioned on the assembled box to aid in breaking down of the assembled box, in accordance with some embodiments discussed herein;

FIG. 16 shows a schematic representation of an example system for forming an assembled box, in accordance with some embodiments discussed herein;

FIG. 17 shows another detailed schematic representation of an example system for forming an assembled box or a stack of tubular knocked-down boxes, in accordance with some embodiments discussed herein; and

FIG. 18 illustrates a flowchart of an example method of forming a box blank, and forming a box from the box blank or a stack of tubular knocked-down boxes, in accordance with some embodiments discussed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

Notably, while some embodiments describe various positional qualifiers for various features, such as “top”, “bottom”, “front”, “back”, “side”, etc., embodiments described herein are not meant to be limited to such qualifiers unless otherwise stated. Directional qualifiers herein are generally used to aid in describing the invention in the context of the drawings and/or description but are not otherwise intended to be limiting.

While some embodiments describe a “user”, use of such a term herein is not meant to be limited to a person or a single person, as the “user” may be an end user, a consumer, a manufacturer, among other types of users along a supply chain in relation to the box design. Further, when utilizing the word “user”, the actor(s) may be operating one or more machines/system that cause the intended function (e.g., forming the box blank or converting the box blank to a box).

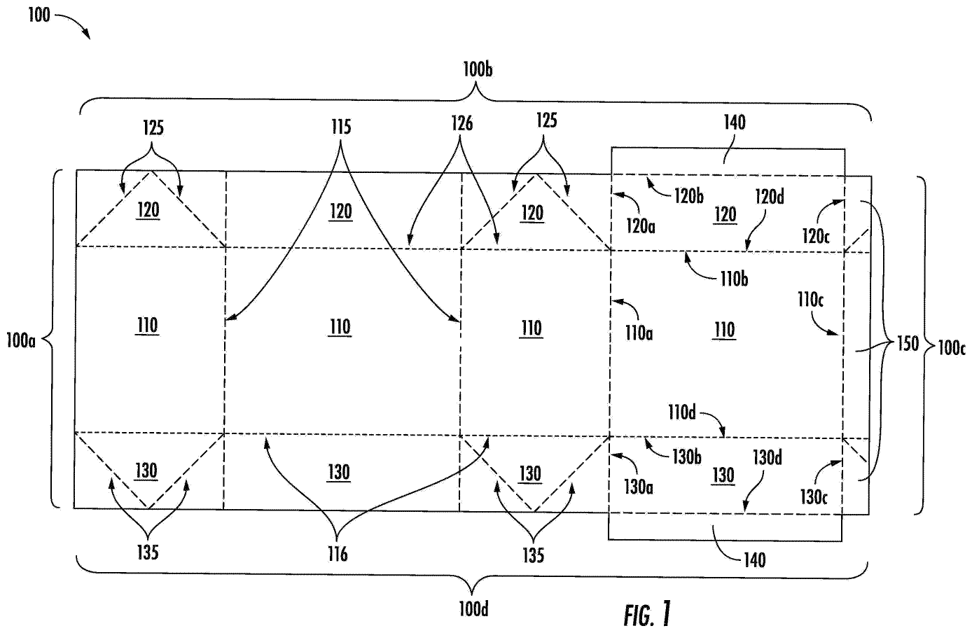

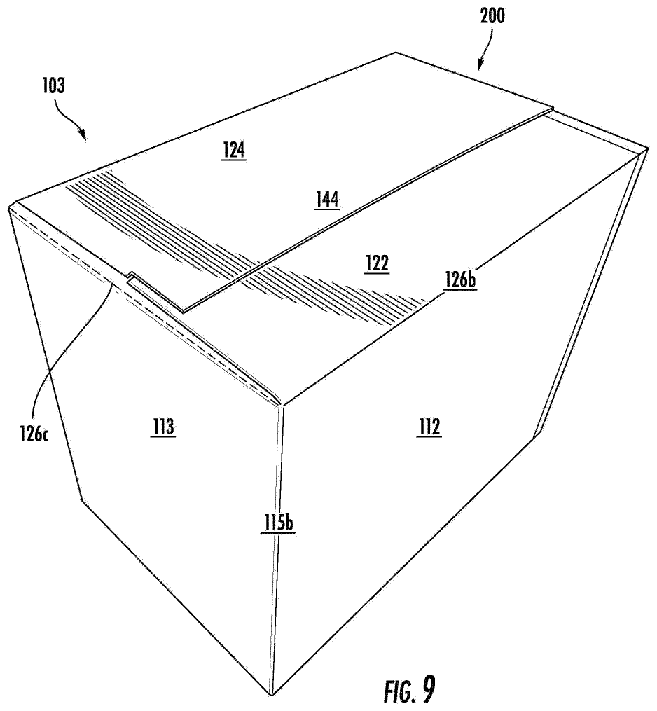

An example box blank 100 is shown in FIGS. 1-3. In some embodiments, the box blank 100 is formed of a continuous piece of material having no cuts between adjacent panels of the box blank. Notably, in some embodiments, as will be discussed in greater detail herein, the box blank 100 may be processed through one or more manufacturing systems to form the box blank 100 and/or a formed box 200, e.g., an erected box, a constructed box, or a ready-to-use box (as shown in FIG. 9). For example, in some embodiments, the box blank 100 may be formed from a web of corrugated material which may be cut into the box blank 100. In some embodiments, the box blank 100 is a single-face corrugated box. Thus, in some embodiments, the box blank 100 includes packaging material made from a single-face corrugated board, which is composed of one layer of flat linerboard, which in an embodiment has a smooth surface, bonded to a single layer fluted corrugated material as will be discussed in greater detail below. In some embodiments, the box blank 100 is a single wall corrugated box. Thus, in some embodiments, the box blank 100 includes packaging material made from one layer of fluted corrugated material enclosed between two flat linerboards. Thereafter, the box blank 100 may be further processed through a die cut to form desired scores thereon. As will be discussed in greater detail below, the box blank 100 does not include any cuts or separations between adjacent panels of the box blank 100. Furthermore, the box blank 100 may be passed through a box maker to form the formed box and/or an intermediate state of the box. In some embodiments, the box blank 100 may be formed of corrugated fiberboard, cardboard, paperboard, and/or other material.

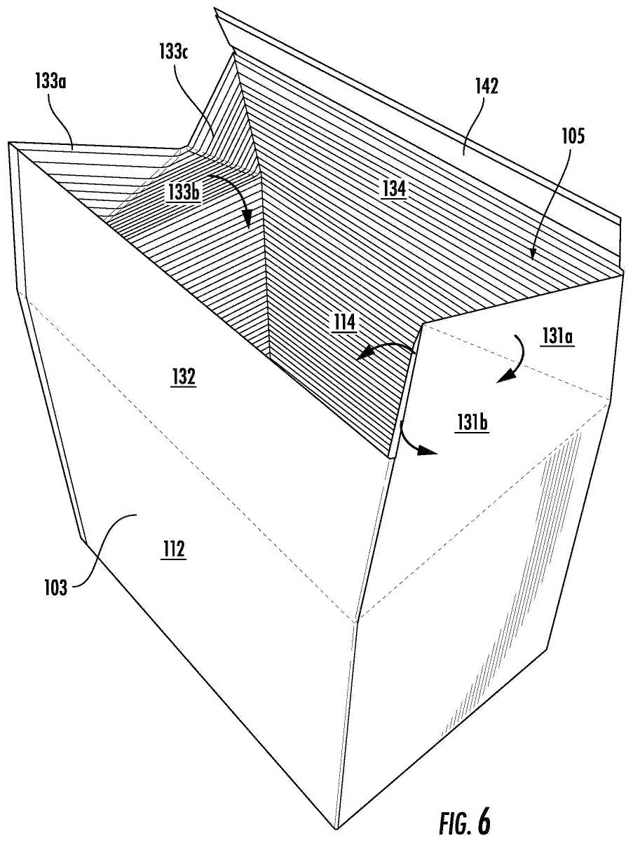

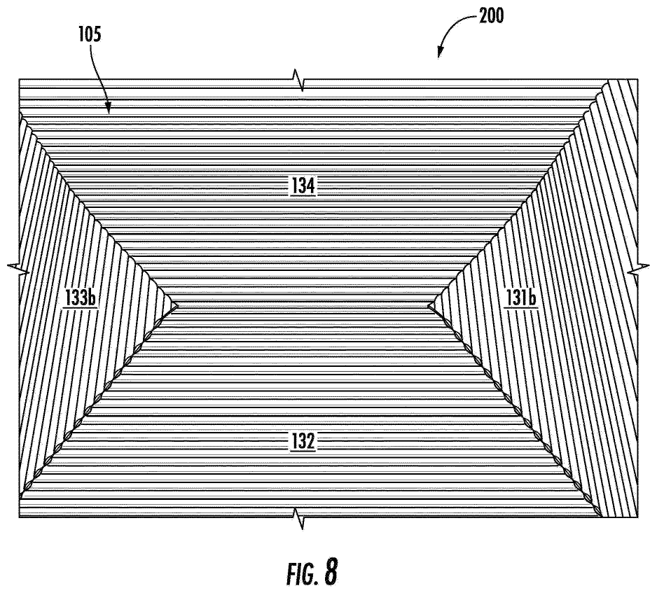

As shown in FIG. 1, in some embodiments, the box blank 100 comprises a plurality of body panels 110, a plurality of top panels 120, a plurality of bottom panels 130, one or more extension portions 140, and one or more glue flaps 150. The box blank 100 may comprise a first outer edge 100a, a second outer edge 100b, a third outer edge 100c, and a fourth outer edge 100d, defining an outer periphery of the box blank 100. In some embodiments, the fourth outer edge 100d may be parallel to the second outer edge 100b and may be perpendicular to both the first outer edge 100a and the third outer edge 100c. In some embodiments, the glue flap 150 may define a portion of the third outer edge 100c. Additionally, in some embodiments, the glue flap 150 may not extend from the fourth outer edge 100d to the second outer edge 100b. In some embodiments, the box blank 100 may define an interior surface 105 of the formed box 200 and an exterior surface 103 of the formed box 200 (see FIGS. 6 and 8).

In some embodiments, the box blank 100 may comprise of multiple adjacent sections, each of the adjacent sections comprising one of the plurality of body panels 110 and one of the plurality of bottom panels 130. In some embodiments, the box blank 100 may comprise multiple adjacent sections, each of the adjacent sections comprising one of the plurality of body panels 110, one of the plurality of bottom panels 130 and one of the plurality of top panels 120.

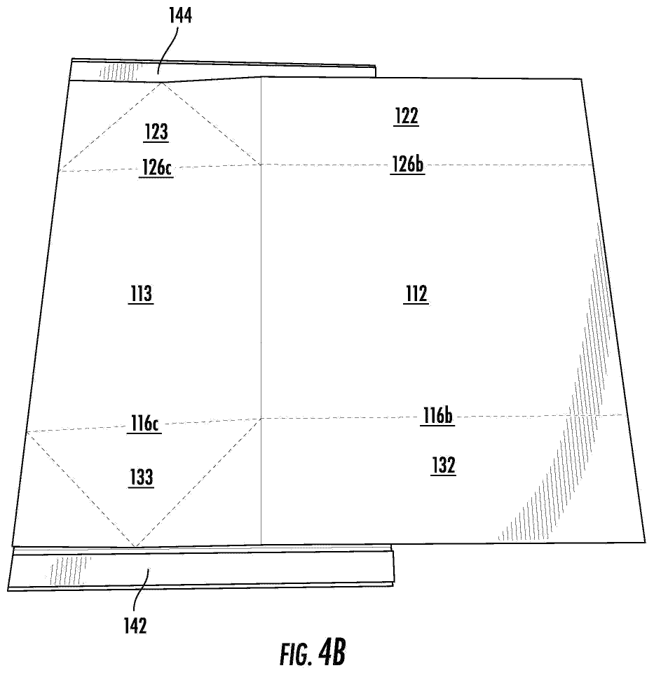

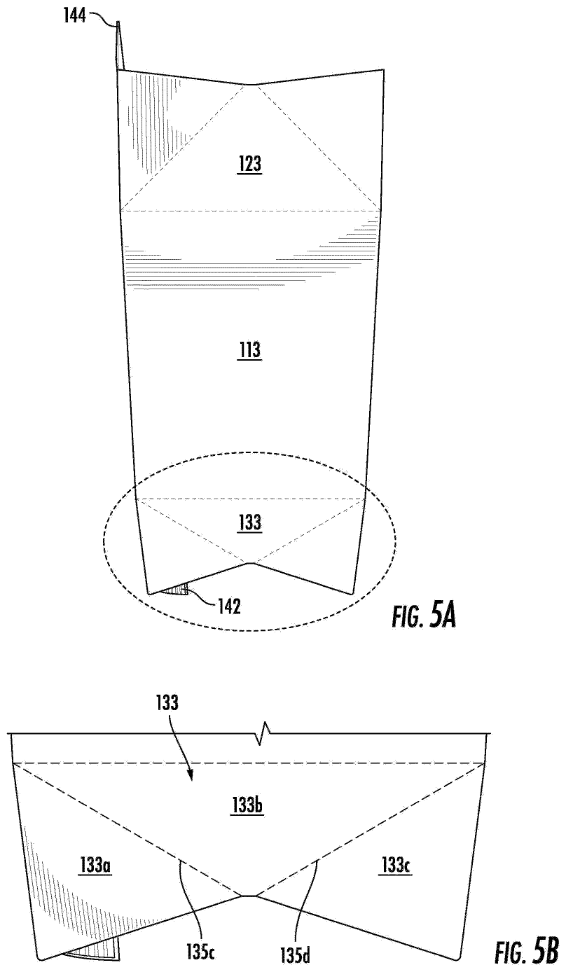

In some embodiments, the plurality of body panels 110 correspond to one or more walls of a formed box 200 (corresponding walls can be seen in the formed box 200 illustrated in FIGS. 5A-10B). In this regard, the term “panels” may be used when in a box blank form and the term “walls” may be used when in the erected/formed box form, although such differentiation in terminology is not required for an understanding of what is being described or claimed.

In some embodiments, the plurality of body panels 110 may be connected to the plurality of bottom panels 130 along a first panel score line 116. The plurality of bottom panels 130 may be positioned opposite the plurality of top panels 120. In some embodiments, the first panel score line 116 may be continuous between the first outer edge 100a and the third outer edge 100c. In some embodiments, the box blank 100 may be foldable along the first panel score line 116.

In some embodiments, the plurality of body panels 110 may be connected to the plurality of the top panels 120 along a second panel score line 126. In some embodiments, the second panel score line 126 may be continuous between the first outer edge 100a and the third outer edge 100c. In some embodiments, the box blank 100 may be foldable along the second panel score line 126.

Adjacent sections may be connected via a corresponding section score line 115. In some embodiments, each section score line 115 may be continuous between the adjacent body panels, the adjacent bottom panels, and the adjacent top panels. In this regard, the section score line 115 may be continuous between the fourth outer edge 100d and the second outer edge 100b. In some embodiments, the box blank 100 may be foldable along the section score line 115. As used herein, the term “score” or “scoring” may be used to describe a compression of the internal support system of the blank without creating a cut therethrough, while in some embodiments the term “score” or “scoring” may include a weakness, creasing, or perforation extending through or partially through the blank 100. Furthermore, in some embodiments, as will be discussed in greater detail herein, a pattern score 135 may be formed within one of the plurality of bottom panels 130 and may assist in erecting the plurality of bottom panels 130 into a bottom portion of the formed box (e.g., FIG. 6). Additionally, or alternatively, a pattern score 125 may be formed within one of the plurality of top panels 120 and may assist in erecting the plurality of top panels 120 into a top portion of the formed box.

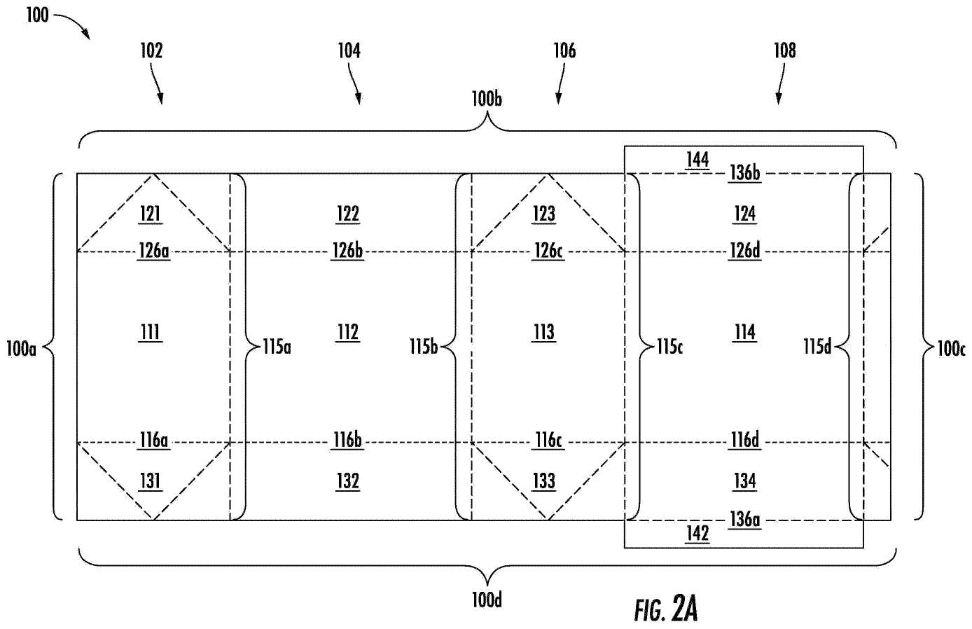

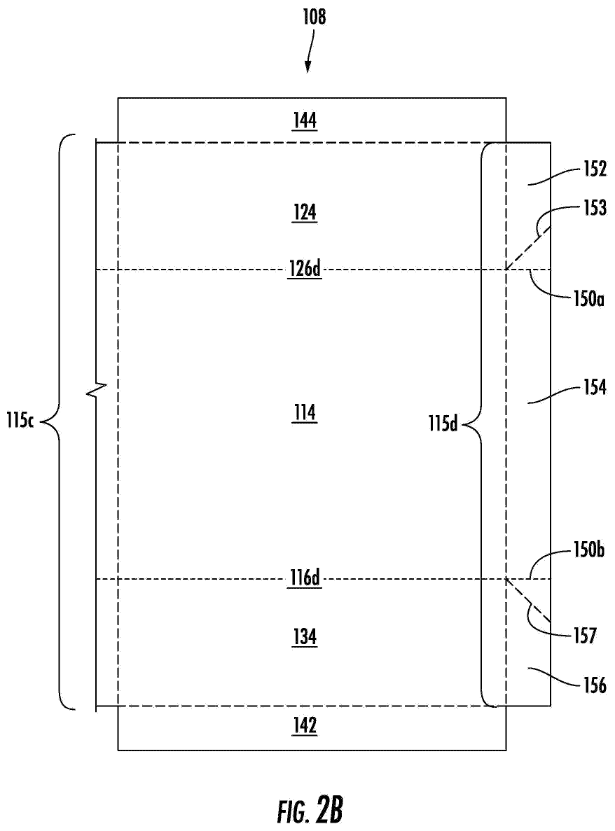

In some embodiments, as shown in FIG. 2A, the box blank 100 may comprise a first section 102, a second section 104, a third section 106, and a fourth section 108. In some embodiments, as will be discussed herein, the first section 102 may be adjacent the second section 104, the second section 104 may be adjacent the third section 106, and the third section 106 may be adjacent the fourth section 108. In some embodiments, the box blank 100 may include more than four sections. In some embodiments, the box blank 100 may include as many sections as needed, and known in the art, to form the formed box 200. While the sections 102, 104, 106, 108 are shown as vertical sections, in some embodiments, the sections may be horizontal sections with the box blank 100 having a plurality of sections.

The first section 102 of the box blank 100 may include at least a first body panel 111 and a first bottom panel 131 connected along a first portion 116a of a first panel score line 116. The second section 104 of the box blank 100 may include at least a second body panel 112 and a second bottom panel 132 connected along a second portion 116b of the first panel score line. The first section 102 and the second section 104 may be connected along a first section score line 115a extending between at least the first body panel 111 and second body panel 112, and between the first bottom panel 131 and the second bottom panel 132.

Similarly, the third section 106 of the box blank 100 may include at least a third body panel 113 and a third bottom panel 133 connected along a third portion 116c of the first panel score line. The second section 104 and the third section 106 may be connected along a second section score line 115b extending between at least the second body panel 112 and third body panel 113, and between the second bottom panel 132 and the third bottom panel 133. Furthermore, the fourth section 108 of the box blank 100 may include at least a fourth body panel 114 and a fourth bottom panel 134 connected along a fourth portion 116d of the first panel score line. The third section 106 and the fourth section 108 may be connected along a third section score line 115c extending between at least the third body panel 113 and the fourth body panel 114, and between the third bottom panel 133 and the fourth bottom panel 134. In some embodiments, each portion of the first panel score line 116, the first section score line 115a, the second section score line 115b, the third section score line 115c and the fourth section score line 115d may be foldable. In some embodiments, each portion of the first panel score line 116, the first section score line 115a, the second section score line 115b, the third section score line 115c and the fourth section score line 115d may include scoring such that each section score line may be folded by a user.

In some embodiments, such as illustrated in FIG. 2A, the first section 102 may include a first top panel 121 connected to the first body panel 111 along a first portion 126a of a second panel score line 126. The first top panel 121 being connected to the first body panel 111 opposite the first bottom panel 131. In some embodiments, the second section 104 may include a second top panel 122 connected to the second body panel 112 along a second portion 126b of the second panel score line. The second top panel 122 being connected to the second body panel 112 opposite the second bottom panel 132. In some embodiments, the first top panel 121 and the second top panel 122 are also connected along the first section score line 115a. Thus, in some embodiments, the first section score line 115a may extend between at least the first top panel 121 and the second top panel 122, between the first body panel 111 and second body panel 112, and between the first bottom panel 131 and the second bottom panel 132.

Furthermore, in some embodiments, the third section 106 may include a third top panel 123 connected to the third body panel 113 along a third portion 126c of the second panel score line. The third top panel 123 being connected to the third body panel 113 opposite the third bottom panel 133. In some embodiments, the second top panel 122 and the third top panel 123 are also connected along the second section score line 115b. Thus, in some embodiments, the second section score line 115b may extend between at least the second top panel 122 and the third top panel 123, between the second body panel 112 and third body panel 113, and between the second bottom panel 132 and the third bottom panel 133.

Additionally, in some embodiments, the fourth section 108 may further comprise a fourth top panel 124 connected to the fourth body panel 114 along a fourth portion 126d of the second panel score line. The fourth top panel 124 being connected to the fourth body panel 114 opposite the fourth bottom panel 134. In some embodiments, the third top panel 123 and the fourth top panel 124 are also connected along the third section score line 115c. Thus, in some embodiments, the third section score line 115c may extend between at least the third top panel 123 and the fourth top panel 124, between the third body panel 113 and fourth body panel 114, and between the third bottom panel 133 and the fourth bottom panel 134. In some embodiments, each portion 126a, 126b, 126c, 126d of the second panel score line may include scoring such that each portion of the second panel score line may be foldable by a user.

In some embodiments, the first outer edge 100a, the second outer edge 100b, the third outer edge 100c, and the fourth outer edge 100d define an outer periphery of the box blank 100. In some embodiments, there are no cut-outs, through-cuts, or intentional cuts or openings between adjacent panels of the box blank 100. In some embodiments, the first section score line 115a, the second section score line 115b, the third section score line 115c and the fourth section score line 115d may include weaknesses, creasing, internal compressions or scoring such that each section score line may be foldable by a user. In some embodiments, each portion of the first panel score line 116 and the second panel score line 126 may include scoring such that each section score line may be foldable by a user. In some embodiments, the panels of the blank box 100 are not separated from each other, e.g., each of the section score lines, each of the first panel score lines and each of the second panel score lines include no cuts, but rather only weaknesses, creasing, scoring, small perforations, or the like such that each score line, and therefore each panel, may be foldable by the user to create the formed box 200.

In some embodiments, the length of each panel of the second section 104 and the fourth section 108 is greater than the length of each panel of the first section 102 and the third section 106. Notably, embodiments of the present invention contemplate various features and configurations of a box blank that can be utilized. Thus, the illustrated example is not meant to be limiting. For example, in some embodiments, the length of each panel of the first section 102 and the third section 106 may be greater than the length of each panel of the second section 104 and the fourth section 108. Additionally, or alternatively, while each of the plurality of panels are shown to be rectangular in shape, other shapes known in the art may be contemplated. In some embodiments, still other configurations are contemplated.

In some embodiments, where the at least one pattern score is positioned along the second bottom panel 132 and the fourth bottom panel 134 (and, where applicable, along the second top panel 122 and the fourth top panel 124) instead of along the first bottom panel 131 and the third bottom panel 133, the first bottom panel 131 and the third bottom panel 133 may not include a pattern score. In such embodiments, when the box blank 100 is assembled into the formed box 200, the pattern scores of the second bottom panel 132 and the fourth bottom panel 134 may enable folding such that the second bottom panel 132 folds towards the fourth bottom panel 134, and the folding may enable the first bottom panel 131 and the third bottom panel 133 to fold on top of the second bottom panel 132 and the fourth bottom panel 134 to form a bottom portion of the formed box. A corresponding arrangement may be provided for the top panels.

In some embodiments, each of the plurality of body panels 110 may define a body panel length, in which the body panel length extends between a first edge 110a of the body panels and a third edge 110c of the body panels. In some embodiments, each of the plurality of body panels 110 define the same body panel width. In some embodiments, each of the plurality of body panels 110 define the same body panel length. However, in some embodiments, the plurality of body panels 110 may include alternate body panel lengths and/or body panel widths. Thus, for example, in some embodiments, the body panel length of the first body panel 111 and the third body panel 113 may be the same length while the body panel width of the second body panel 112 and the fourth body panel 114 may be the same width.

In some embodiments, each of the plurality of bottom panels 130 may define a bottom panel length, in which the bottom panel length extends between a first edge 130a of the bottom panels and a third edge 130c of the bottom panels. In some embodiments, each of the plurality of bottom panels 130 define the same bottom panel width. In some embodiments, each of the plurality of bottom panels 130 define the same bottom panel length. However, in some embodiments, the plurality of bottom panels 130 may include alternate bottom panel lengths and/or bottom panel widths. Thus, for example, in some embodiments, the bottom panel length of the first bottom panel 131 and the third bottom panel 133 may be the same length while the bottom panel width of the second bottom panel 132 and the fourth bottom panel 134 may be the same width.

In some embodiments, each of the plurality of top panels 120 may define a top panel length, in which the top panel length extends between a first edge 120a of the top panels and a third edge 120c of the top panels. In some embodiments, each of the plurality of top panels 120 define the same top panel width. In some embodiments, each of the plurality of top panels 120 define the same top panel length. However, in some embodiments, the plurality of top panels 120 may include alternate top panel lengths and/or top panel widths. Thus, for example, in some embodiments, the top panel length of the first top panel 121 and the third top panel 123 may be the same length while the top panel width of the second top panel 122 and the fourth top panel 124 may be the same width.

In some embodiments, the box blank 100 may further include a glue flap 150 (see FIG. 1). Referring to FIG. 2B, the glue flap 150 may comprise at least a first glue flap panel 154 connected to either the first section 102 or the fourth section 108 of the box blank 100. In some embodiments the glue flap 150 may define a portion of the third outer edge 100c and, in some embodiments, may not extend from the fourth outer edge 100d to the second outer edge 100b. In some embodiments, the glue flap 150 may define a portion of the first outer edge 100a. In an embodiment, the glue flap 150 may comprise at least a first glue flap panel 154, a second glue flap panel 156 and a third glue flap panel 152. In some embodiments, the first glue flap panel 154 is connected to the second glue flap panel 156 along a fifth portion 150b of the first panel score line 116. In some embodiments, the first glue flap panel 154 is connected to the third glue flap panel 152 along a fifth portion 150a of the second panel score line 126. In some embodiments, the second glue flap panel 156 may be opposite the third glue flap panel 152. In some embodiments, the glue flap 150 may comprise any combination of the first glue flap panel 154, the second glue flap panel 156 and the third glue flap panel 152. In some embodiments, the glue flap 150 may comprise only the first glue flap panel 154.

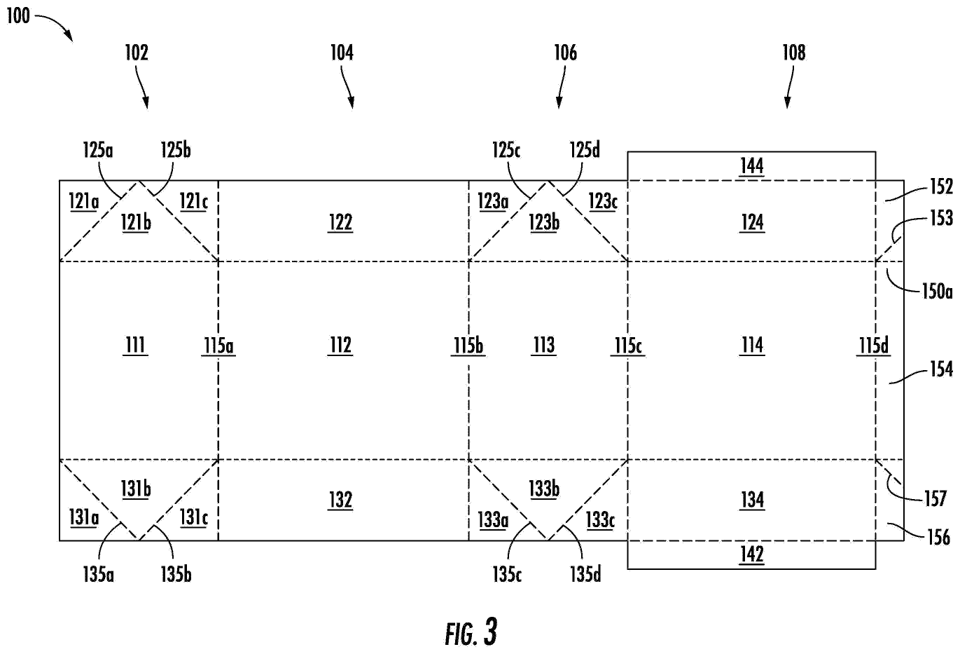

In an embodiment, the second glue flap panel 156 may include a second glue flap score line 157. In some embodiments, the second glue flap score line 157 may align with a portion of a score line 135a of the first pattern score of the first bottom panel 131, as shown in FIG. 3 and discussed in greater detail below, when the glue flap 150 is connected to the first section 102 along the fourth section score line 115d. In some embodiments, the second glue flap score line 157 allows the glue flap 150 to be able to fold with the first bottom panel 131 and form the bottom portion of the assembled box 200. In an embodiment, the third glue flap panel 152 may include a third glue flap score line 153. In some embodiments, the third glue flap score line 153 may align with a portion of a score line 125a of the third pattern score of the first top panel 121, as shown in FIG. 3 and discussed in greater detail below, when the glue flap 150 is connected to the first section 102 along the fourth section score line 115d. In some embodiments, the third glue flap score line 153 allows the glue flap 150 to be able to fold with the first top panel 121 and form the top portion of the assembled box 200. In an embodiment, the second glue flap score line 157 and the third glue flap score line 153 may be a diagonal score line having an approximately 45-degree angle to the fourth section score line 115d. However, in some embodiments, the second glue flap score line 157 and the third glue flap score line 153 may include any shape known in the art to be able to align with the score lines 125a, 135a respectively when the glue flap 150 is connected to the first section 102 and when the top and/or bottom portions of the box 200 is formed.

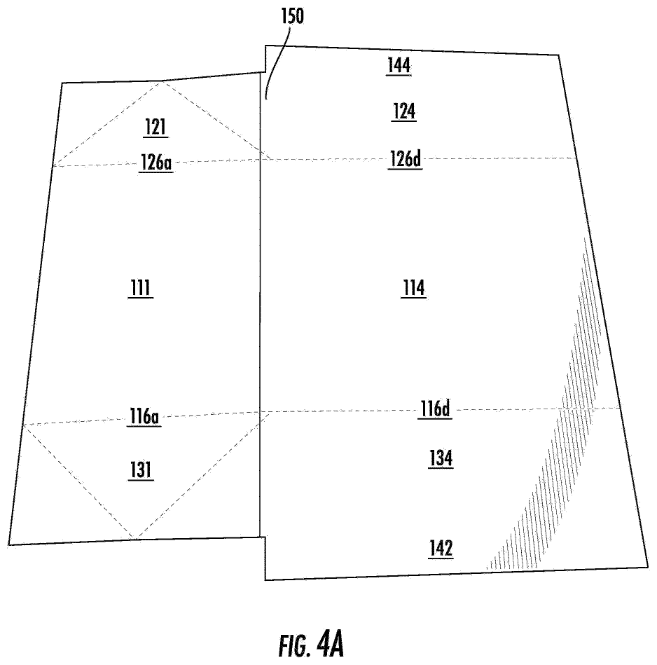

In some embodiments, the glue flap 150 may be connected to the fourth section 108 along a fourth section score line 115d extending between at least the fourth top panel 124 and the third glue flap panel 152, between the fourth body panel 114 and the first glue flap panel 154, and between the fourth bottom panel 134 and the second glue flap panel 156. Although illustrated as being attached to the fourth section 108 of the box blank 100, the glue flap 150 may alternatively be attached to the first section 102. In some embodiments, the first glue flap panel 154, the second glue flap panel 156 and/or the third glue flap panel 152 may further include additional scoring within each of the glue flap panels to be folded or connected to either the first section 102 or the fourth section 108. As shown in FIGS. 4A-4B, in some embodiments, the box blank 100 is configured to be assembled into a tubular knocked down box when the glue flap 150 is connected to either the first section 102 or the fourth section 108 along the fourth section score line 115d.

As illustrated in FIGS. 3 and 5A-5B, in some embodiments, the box blank 100 may include at least one pattern score. In some embodiments, the at least one pattern score may be positioned on at least one of the first bottom panel 131, the second bottom panel 132, the third bottom panel 133 or the fourth bottom panel 134. In some embodiments, the at least one pattern score may be positioned on the first bottom panel 131, the third bottom panel 133, the first top panel 121 and the third top panel 123. As discussed herein, the at least one pattern score is configured to aid in the folding of the plurality of bottom panels 130 and/or the plurality of top panels 120 into a bottom portion and/or a top portion of the formed box.

The box blank 100 may comprise a first pattern score positioned along the first bottom panel 131, the first pattern score having one or more score lines 135a, 135b separating the first bottom panel 131 into at least three sections 131a, 131b, 131c. The box blank 100 may further comprise a second pattern score positioned along the third bottom panel 133, the second pattern score having one or more score lines 135c, 135d separating the third bottom panel 133 into at least three sections 133a, 133b, 133c. In some embodiments, the second bottom panel 132 and the fourth bottom panel 134 may not include a pattern score. Thus, in some embodiments, only the first bottom panel 131 and the third bottom panel 133 include pattern scores. In some embodiments, the first bottom panel 131 with the first pattern score may be pre-crushed to aid in folding of the first bottom panel 131. In some embodiments, the third bottom panel 133 with the second pattern score may be pre-crushed to aid in folding of the third bottom panel 133. In some embodiments, the process of pre-crushing the panels, and thus the flutes, of a box involves partially weakening the panels, and compressing the flutes, so that the flutes are easier to flex, allowing for smoother box formation and reducing resistance during folding. Thus, in some embodiments, the pre-crushing of the first bottom panel 131 with the first pattern score and the third bottom panel 133 with the second pattern score ensures that when the box blank 100 is assembled into the formed box 200, the first bottom panel 131 with the first pattern score and the third bottom panel 133 with the second pattern score may fold more easily, guiding the first bottom panel 131 toward the third bottom panel 133 while preventing unintended folding of adjacent panels.

In some embodiments, the one or more score lines may include two diagonal score lines. In some embodiments, the first pattern score of the first bottom panel 131 may include a diagonal score line 135a and a diagonal score line 135b. In some embodiments, the second pattern score of the third bottom panel 133 may include a diagonal score line 135c and a diagonal score line 135d. In some embodiments, the one or more score lines are configured to create at least a first triangular-shaped section 131a, 133a, a second triangular-shaped section 131b, 133b and a third triangular-shaped section 131c, 133c along each of the first bottom panel 131 and the third bottom panel 133 respectively. In some embodiments, the one or more score lines may create a V-shape score line positioned on the first bottom panel 131 and the third bottom panel 133. In some embodiments, a first score line and a second score line, for example 135a, 135b, may start at opposite corners of the first bottom panel 131 and meet at a single central point of the first bottom panel 131. However, in some embodiments, other pattern score shapes may be considered to aid in the folding of the plurality of bottom panels 130 into a bottom portion of the formed box.

In some embodiments, once the glue flap is connected to either the first section 102 or the fourth section 108 along the fourth section score line 115d to create a tubular knocked down box, the first pattern score and the second pattern score may enable the plurality of bottom panels 130 to fold into the bottom portion of the formed box (see FIGS. 6 and 8) while maintaining continuity between each of the sections. To explain, the pattern scores of the first bottom panel 131 and the third bottom panel 133 allow the plurality of bottom panels to fold and form into a bottom structure in a way such that the plurality of bottom panels 130 may fold sequentially, e.g., interdependently, of one another. In some embodiments, the pattern scores of the first bottom panel 131 and the third bottom panel 133 allow the plurality of bottom panels to fold and form into a bottom structure in a way such that the plurality of bottom panels 130 may fold simultaneously of one another. In this regard, the plurality of bottom panels 130 may be continuous along the box blank 100 having no cuts or separations between the panels of the box blank 100. In some embodiments, referring FIG. 2B, because the score line shape of the second glue flap score line 157 of the second glue flap panel 156 aligns with a portion of the pattern score of the first bottom panel 131, the glue flap (now connected to the first section 102 along the fourth section score line 115d) may allow folding of the bottom panels to the bottom portion of the formed box.

FIG. 6 illustrates the formation of a bottom portion of an assembled box, including a folding direction of the plurality of triangular shaped sections of the first bottom panel 131 and the third bottom panel 133. In some embodiments, the pattern scores of the box blank 100 enable the box blank to fold progressively, with each of the plurality of bottom panels 130 folding sequentially and in correspondence with each other based on the score lines on the first bottom panel 131 and third bottom panel 133. Thus, in some embodiments, once a user begins folding, e.g., pushing, pressing, motioning, one of the bottom panels 130 having pattern scores in the folding direction, e.g., towards the interior center of the box (see FIG. 6), this motion by the user causes the other bottom panels of the box to also begin moving towards the interior center of the box. In some embodiments, a user may fold one bottom panel having a pattern score at a time in the folding direction. In some embodiments, a user may fold both bottom panels having pattern scores at the same time in the folding direction. The interdependent folding of the box blank 100, having no major cuts or separations in the box blank 100, ensures that the box is assembled in a coordinated and efficient manner without the need for folding four separate panels and the need for external tools for closure, as will be discussed below.

In some embodiments, when the box blank 100 is assembled into the formed box 200, the first pattern score and the second pattern score enable folding such that the first bottom panel 131 folds towards the third bottom panel 133. In some embodiments, the folding is such that the first pattern score and the second pattern score enable folding such that the second triangular-shaped section 131b, 133b is folded first towards the center of the box, and thus towards one another. Since the panels of the box blank 100 are continuous and not separate from each other, in some embodiments, the folding of the second triangular-shaped sections 131b, 133b in a downward direction towards the center of the box interdependently enables the first triangular-shaped sections 131a, 133a and the third triangular-shaped sections 131c, 133c of the first bottom panel 131 and the third bottom panel 133 to fold over the second triangular-shaped sections 131b, 133b, as shown in FIG. 6. In some embodiments, since the panels of the box blank 100 include no cuts, the folding of the first triangular-shaped sections 131a, 133a and the third triangular-shaped sections 131c, 133c then causes the second bottom panel 132 and the fourth bottom panel 134 to fold on top of the first bottom panel 131 and the third bottom panel 133 to form the bottom portion of the formed box. In some embodiments, the first bottom panel 131 and the third bottom panel 133 are pre-crushed to aid in folding of the panels. In some embodiments, the first pattern score and the second pattern score may include scoring along the diagonal score lines 135a, 135b, 135c, 135d, such that each of the pattern scores may be folded and enable the sequential folding of the bottom portion of the box.

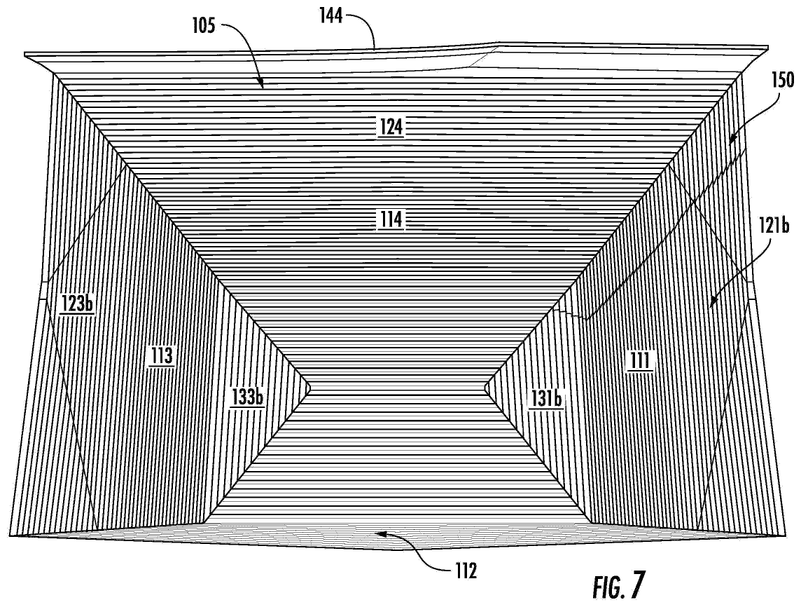

Furthermore, in some embodiments, as illustrated in FIGS. 7 and 8, the folding of the second triangular-shaped sections 131b, 133b in a downward direction towards the center of the box, which then enables the first triangular-shaped sections 131a, 133a and the third triangular-shaped sections 131c, 133c of the first bottom panel 131 and the third bottom panel 133 over the second triangular-shaped sections 131b, 133b, creates one or more triangular protrusions (e.g., 133b and 131b of FIG. 7) positioned in the interior 105 of the formed box when the box is formed. In some embodiments, the one or more triangular protrusions aid in stabilizing an item placed inside the formed box. In some embodiments, the one or more triangular protrusions aid in protecting an item placed inside the formed box from damage. In some embodiments, the one or more triangular protrusions aid in resistance of movement of an item placed inside the formed box.

In some embodiments, as discussed above, a third pattern score may be positioned on the first top panel 121, the third pattern score having one or more score lines 125a, 125b separating the first top panel 121 into at least three sections 121a, 121b, 121c. In some embodiments, a fourth pattern score may be positioned on the third top panel 123, the fourth pattern score having one or more score lines 125c, 125d separating the third top panel 123 into at least three sections 123a, 123b, 123c. In some embodiments, the second top panel 122 and the fourth top panel 124 may not include a pattern score. Thus, in some embodiments, only the first bottom panel 131, the third bottom panel 133, the first top panel 121 and the third top panel 123 include pattern scores. In some embodiments, the one or more score lines may include two diagonal score lines. In some embodiments, the first top panel 121 with the third pattern score may be pre-crushed to aid in folding of the first top panel 121. In some embodiments, the third top panel 123 with the fourth pattern score may be pre-crushed to aid in folding of the third top panel 123. In some embodiments, the process of pre-crushing the panels, and thus the flutes, of a box involves partially weakening the panels, and compressing the flutes, so that the flutes are easier to flex, allowing for smoother box formation and reducing resistance during folding. Thus, in some embodiments, the pre-crushing of the first top panel 121 with the third pattern score and the third top panel 123 with the fourth pattern score ensures that when the box blank 100 is assembled into the formed box 200, the first top panel 121 with the third pattern score and the third top panel 123 with the fourth pattern score may fold more easily, guiding the first top panel 121 toward the third top panel 123 while preventing unintended folding of adjacent panels.

In some embodiments, the third pattern score of the first top panel 121 may include diagonal score line 125a and diagonal score line 125b. In some embodiments, the fourth pattern score of the third top panel 123 may include diagonal score line 125c and diagonal score line 125d. In some embodiments, the one or more score lines are configured to create at least a first triangular-shaped section 121a, 123a, a second triangular-shaped section 121b, 123b and a third triangular-shaped section 121c, 123c along each of the first top panel 121 and the third top panel 123.

In some embodiments, once the glue flap is connected to either the first section 102 or the fourth section 108 along the fourth section score line 115d to create a tubular knocked down box, as illustrated in FIGS. 4A-4B, the third pattern score and the fourth pattern score may enable the plurality of top panels 120 to fold into a top portion of the formed box as described above for the plurality of bottom panels 130. Thus, in some embodiments, the pattern score lines of the box blank 100 enables the box blank to fold progressively, with each of the plurality of top panels 120 folding sequentially and in correspondence with each other based on the pattern score lines on the first top panel 121 and third top panel 123. In some embodiments, the pattern score lines of the box blank 100 enables the box blank to fold progressively, with each of the plurality of top panels 120 folding in correspondence with each other based on the pattern score lines on the first top panel 121 and third top panel 123 (e.g., one leading to the other and/or simultaneously). While it is depicted that both the plurality of bottom panels and the plurality of top panels include one or more pattern score lines, in some embodiments, only the bottom panels 130 may include pattern score lines positioned on the first bottom panel 131 and the third bottom panel 133 while the top panels 120 may include other methods of forming the top portion of the formed box. In some embodiments, the top panels 120 may include various cuts or separations, while the bottom panels 130 are continuous, as described above.

In some embodiments, as illustrated in FIGS. 2A, 7 and 6, at least two extension portions 142, 144 may be connected to the second top panel 122 and the second bottom panel 132 of the second section 104 or the fourth top panel 124 and the fourth bottom panel 134 of the fourth section 108. In some embodiments, a first extension portion 142 may be connected to the fourth bottom panel 134 along a first extension portion score line 136a. In some embodiments, the first extension portion 142 may be connected to the second bottom panel 132 along a first extension portion score line 136a. In some embodiments, the first extension portion 142 may be connected to the second and/or fourth bottom panels 132, 134 opposite the second and/or fourth body panels 112, 114. In some embodiments, a second extension portion 144 may be connected to the fourth top panel 124 along a second extension portion score line 136b. In some embodiments, the second extension portion 144 may be connected to the second top panel 122 along a second extension portion score line 136b. In some embodiments, the second extension portion 144 may be connected to the second and/or fourth top panels 122, 124 opposite the second and/or fourth body panels 112, 114. In some embodiments, the first extension portion 142 may be connected to the fourth bottom panel 134 while the second extension portion 144 may be connected to the second top panel 122. In some embodiments, the first extension portion 142 may be connected to the second bottom panel 132 while the second extension portion 144 may be connected to the fourth top panel 124. In some embodiments, the first extension portion 142 and the second extension portion 144 extending from different sections from each other on a box blank 100 allows for less waste scrap in the production of the box blank 100. In some embodiments, the first extension portion 142 and the second extension portion 144 may be formed as part of a continuous sheet with the rest of the box blank 100. In some embodiments, the first extension portion 142 and/or the second extension portion 144 may be a separate element that is bonded to the box blank 100.

In some embodiments, as illustrated in FIGS. 6-7 and 9, each of the at least two extension portions 142, 144 may include adhesive material to aid in assembling the box. In some embodiments, the adhesive material may be placed on at least some portions or all of the extension portions 142, 144. In some embodiments, the adhesive material of the at least two extension portions 142, 144 may further include a release liner or backing paper on top of the adhesive material that may be removed before use by a user.

In some embodiments, the first extension portion score line 136a and/or the second extension portion score line 136b may include a score, a perforation, or a combination thereof, to allow the respective extension portion 142, 144 to bend relative to the adjacent panel. In some embodiments, the ability of the extension portion 142, 144 to bend along the extension portion score line 136a, 136b allows the extension portion 142, 144 to fold out of the way during packing of the box. In some embodiments, by bending out of the way, the extension portion 142, 144 allows the end of the box that is against a surface to sit flat while a user closes the other end of the box. In some embodiments, the extension portion 142, 144 may be bent upward after the flap area of the box is already closed, allowing the user to remove the release liner from the adhesive material and seal the extension portion 142, 144 onto the receiving portion of the adjacent panel. In some embodiments, the score, perforation, or combination thereof along the extension portion score line 136a, 136b may be configured to provide sufficient flexibility for the extension portion 142, 144 to bend during packing while maintaining structural integrity of the connection between the extension portion 142, 144 and the adjacent panel.

In some embodiments, once the box blank 100 is assembled into the formed box 200 such that the first bottom panel 131 folds towards the third bottom panel 133, and thus enables the second bottom panel 132 and the fourth bottom panel 134 to fold on top of the first bottom panel 131 and the third bottom panel 133 to form a bottom portion of the formed box 200, the first extension portion 142 may be placed on a receiving portion of the second bottom panel 132, thus securing the box in a closed configuration. In some embodiments, the first extension portion 142 may have the same length as the second bottom panel 132, or the fourth bottom panel 134, to which the first extension portion 142 is connected to. Thus, in some embodiments, for example, the first extension portion score line 136a of the first extension portion 142 may extend from the third section score line 115c to the fourth section score line 115d (see FIG. 2A). In some embodiments, when the first extension portion 142 is the same length as the fourth bottom panel 134, the edge (e.g., corner) of the formed box 200 provides the user support to press the adhesive of the first extension portion 142 onto the receiving portion of the second bottom panel 132 and completely covering the second bottom panel 132 once the first extension portion 142 is pressed onto the second bottom panel 132.

Additionally or alternatively, once the box blank 100 is assembled into the formed box 200 such that the first top panel 121 folds towards the third top panel 123, which enables the second top panel 122 and the fourth top panel 124 to fold on top of the first top panel 121 and the third top panel 123 to form a top portion of the formed box 200, the extension portion 144 may enable closing of the box. As illustrated in FIG. 9, in some embodiments, the second extension portion 144 may be placed on a receiving portion of the second top panel 122, thus securing the box in a closed configuration. In some embodiments, the second extension portion 144 may have the same length as the second top panel 122, or the fourth top panel 124, to which the second extension portion 144 is connected to. Thus, in some embodiments, for example, the second extension portion score line 136b of the second extension portion 144 may extend from the third section score line 115c to the fourth section score line 115d (see FIG. 2A). In some embodiments, when the second extension portion 144 is the same length as the fourth top panel 124, the edge (e.g., corner) of the formed box 200 provides the user support to press the adhesive of the second extension portion 144 onto the receiving portion of the second top panel 122 and completely covering the second top panel 122 once the second extension portion 144 is pressed onto the second top panel 122. In some embodiments, the box blank 100 is formed into the box 200 without the use of external tools. In some embodiments, the box blank is formed into the box without the use external tools, including tape, external adhesives, or other external box closing tools known in the art.

In some embodiments, the location of the one or more extension portions 142, 144 may correspond to the location of the panels that do not include the pattern scores, regardless of which sections those panels belong to. For example, in some embodiments in which the pattern scores are positioned along the second bottom panel 132, the second top panel 122, the fourth bottom panel 134, and/or the fourth top panel 124, the one or more extension portions 142, 144 may instead be connected to one or more of the first body panel 111, the third body panel 113, the first top panel 121, the third top panel 123, the first bottom panel 131, and/or the third bottom panel 133 along respective extension portion score lines. In some embodiments, the first extension portion 142 may be connected to the third bottom panel 133 and the second extension portion 144 may be connected to the third top panel 123. In some embodiments, the first extension portion 142 and the second extension portion 144 may be connected to corresponding panels of the first section 102. Although certain figures depict the extension portions 142, 144 attached to particular panels, the extension portions 142, 144 may be attached to any panel of the box blank 100 that is suitable to aid in closing and sealing the formed box.

In some embodiments, instead of the glue flap 150 being connected to the adjacent section such that a seam between the first glue flap panel 154 and the adjacent body panel is positioned substantially along an edge of a wall of the formed box 200, the glue flap 150 may be configured such that the seam runs along a center of a body panel of the box blank 100. In some such embodiments, the first glue flap panel 154 may have a width that is substantially equal to a width of an adjacent body panel of the box blank 100, such as the fourth body panel 114, or alternatively the first body panel 111 when the glue flap 150 is connected to the first section 102. When the glue flap 150 is connected to either the first section 102 or the fourth section 108, the first glue flap panel 154 may overlap the adjacent body panel along substantially the entire width of that body panel, such that a free edge of the first glue flap panel 154 lands at or near a center of the adjacent body panel. The resulting seam may thereby run down a center of the fourth body panel 114, or alternatively down a center of the first body panel 111, and along a center of a corresponding wall of the formed box 200. In some embodiments, an adhesive material may be applied between overlapping portions of the first glue flap panel 154 and the adjacent body panel to secure the glue flap 150 in the center seam configuration.

In some embodiments, as illustrated in FIGS. 7 and 8, the box is a single-face corrugated box. Thus, in some embodiments, the box includes packaging material made from single-face corrugated board, which is composed of one layer of flat linerboard, which in an embodiment has a smooth surface, bonded to a single layer of fluted corrugated material. While FIGS. 7 and 8 illustrate a single-face corrugated box, in some embodiments, the box may be a single wall corrugated box. Thus, in some embodiments, the box includes packaging material made from one layer of fluted corrugated material enclosed between and bonded to two flat linerboards. In some embodiments, either the single-face corrugated box or the single wall corrugated box provide a combination of strength and cushioning, making it suitable for certain applications.

In some embodiments, the box blank 100 includes a plurality of flutes positioned on the interior surface 105 of the box, each defining a longitudinal axis that extends perpendicularly to the first, the second, the third, and the fourth section score lines and parallel to the first and the second panel score lines. In some embodiments, the positioning of the plurality of flutes perpendicularly to the first, the second, the third, and the fourth section score lines and parallel to the first and the second panel score lines provides a combination of strength and cushioning to the formed box 200 and an item therein. In some embodiments, because the plurality of flutes are perpendicular to the first, the second, the third, and the fourth section score lines and parallel to the first and the second panel score lines, this allows for the box to not fold over at the section score lines and creates an additional layer of strength to the box. In some embodiments, because the plurality of flutes are perpendicular to the first, the second, the third, and the fourth section score lines and parallel to the first and the second panel score lines, this allows for the box body, e.g., the plurality of body panels, to maintain a desired shape while the user erects the box. In some embodiments, if the plurality of flutes are parallel to the first, the second, the third, and the fourth section score lines and perpendicular to the first and the second panel score lines, the box body, e.g., the plurality of body panels, does not hold its desired shape and erecting the box may be more difficult for the user (e.g., the user may accidentally form their own folds).

In some embodiments, because the plurality of flutes are parallel to the first and the second panel score lines, the single-face corrugated material may exhibit reduced scoring memory along the first panel score line 116 and the second panel score line 126. In some embodiments, scoring memory refers to the tendency of a scored material to retain a fold or crease along a score line after the scoring operation. In some embodiments, because the flutes extend in the same direction as the first and the second panel score lines, the single-face corrugated material may not retain sufficient scoring memory along the first and the second panel score lines when only scoring is applied. In some embodiments, to address the reduced scoring memory, at least one of the first panel score line 116 or the second panel score line 126 may include one or more perforations to aid in folding of the box blank 100 along the first panel score line 116 or the second panel score line 126. In some embodiments, the one or more perforations may be used in addition to scoring along the first panel score line 116 or the second panel score line 126. In some embodiments, the one or more perforations may be used instead of scoring along the first panel score line 116 or the second panel score line 126. In some embodiments, the combination of perforations and scoring along the first and the second panel score lines provides improved fold definition and consistency compared to scoring alone. In some embodiments, the section score lines 115a, 115b, 115c, 115d, which extend perpendicularly to the plurality of flutes, may be scored without the need for perforations, as the single-face corrugated material may retain sufficient scoring memory in the direction perpendicular to the flutes.

In some embodiments, the combination of the flute orientation and the pre-crushing of the pattern score areas enables the box blank 100 to be a hand erectable single-face box. In some embodiments, the orientation of the plurality of flutes perpendicular to the section score lines provides sufficient stiffness to the body panels 111, 112, 113, 114 such that the body panels maintain their desired shape during hand erecting of the box, preventing the body panels from unintentionally folding or collapsing. In some embodiments, the pre-crushing of the first bottom panel 131 with the first pattern score and the third bottom panel 133 with the second pattern score may weaken the flutes along the pattern score areas, enabling the bottom panels to fold easily and predictably during hand erecting without requiring excessive force. In some embodiments, without the pre-crushing, the pattern score areas of a single-face box may resist folding due to the stiffness of the uncrushed flutes, making hand erecting difficult. In some embodiments, without the flute orientation perpendicular to the section score lines, the body panels of a single-face box may lack sufficient stiffness to maintain their shape during hand erecting, causing the box to be too flimsy to erect by hand. In some embodiments, the combination of the flute orientation and the pre-crushing thus enables efficient hand erecting and packing of the single-face box, allowing a user to erect and close the box without the need for external tools or machinery.

In some embodiments, the box blank having a single wall corrugated material may also include a plurality of flutes, positioned between two flat linerboards, being perpendicular to the first, the second, the third, and the fourth section score lines and parallel to the first and the second panel score lines. In some embodiments, the positioning of the plurality of flutes perpendicular to the first, the second, the third, and the fourth section score lines and parallel to the first and the second panel score lines provides a combination of strength and cushioning to the formed box 200 and an item therein.

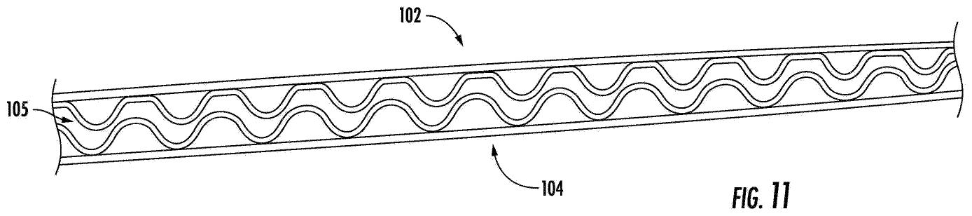

In some embodiments, as illustrated in FIG. 11, placement of the plurality of flutes on the first section 102 and the fourth section 108 of the box are offset by a distance of approximately one-half of a flute pitch from the plurality of flutes positioned on the second section 104 and the third section 106 of the box. In some embodiments, the offset placement of the plurality of flutes allows the first section 102 and the fourth section 108 of the box to nest into the second section 104 and the third section 106 of the box when the box is in a flat knocked-down tubular form. Thus, in an embodiment, the plurality of flutes may provide structural strength to the box when assembled while saving space during storage and transportation of the flat knocked-down tubular form of the box.

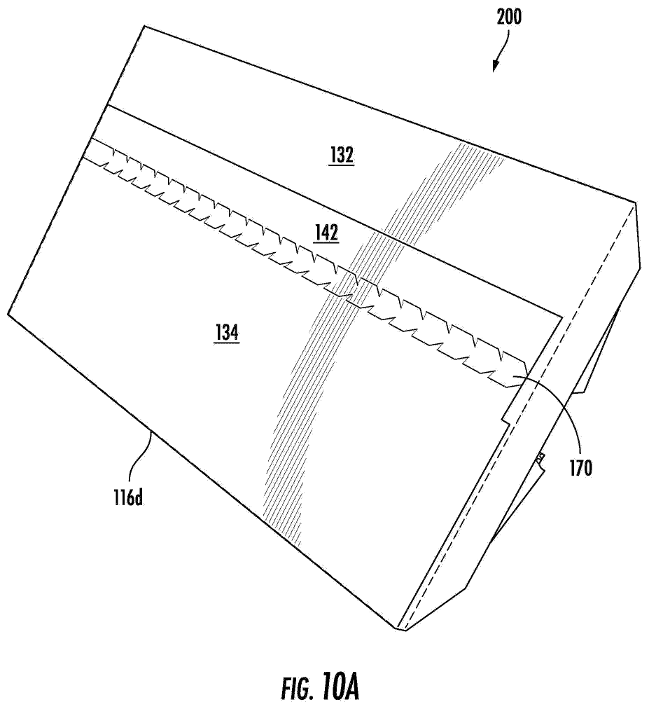

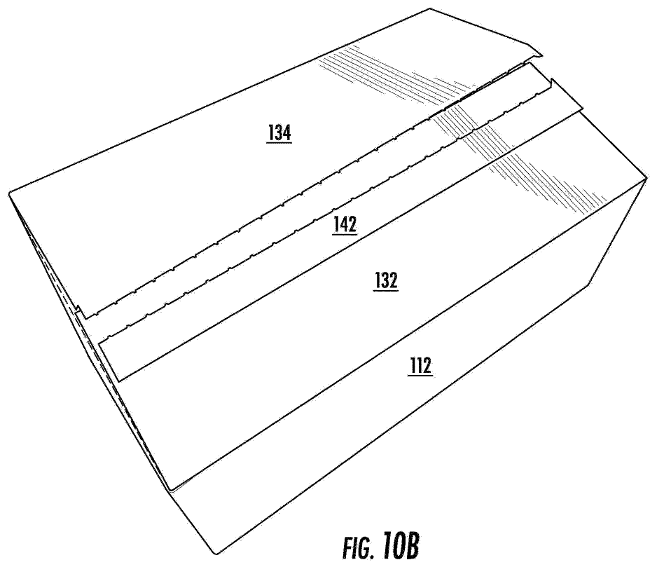

In some embodiments, as illustrated in FIGS. 10A-10B, the box, having one or more extensions portions 142, 144, may further include one or more tear strips 170 positioned between one or more of the extension portions 142, 144 and the second top panel 122 of the second section 104, the second bottom panel 132 of the second section 104, the fourth top panel 124 of the fourth section 108 or the fourth bottom panel 134 of the fourth section 108. In some embodiments, the tear strip 170 may comprise pre-scored weakened sections, perforations, score lines, adhesive, or other attachment methods along the tear strip 170 to hold the tear strip 170 intact to the box for some time. In some embodiments, after the adhesive material of the one or more extensions portions 142, 144 is used to close the box, a user may open the box by pulling along the perforation or adhesive seam of the tear strip 170 to detach the tear strip 170 from the box and therefore open the box. In some embodiments, once removed, the tear strip 170 exposes the opening mechanism or access point of the box, e.g., the panels of the box, allowing a user to lift the panels and access the box's contents without need for external tools.

In some embodiments, the tear strip 170 may be an added material attached or bonded to the box blank 100 or may be formed using perforations in the existing material of the box blank 100. In some embodiments, the tear strip 170 may comprise a strip of material, such as a paper-based strip, a plastic strip, a fiber-reinforced strip, or a combination thereof, that is adhered to the exterior or interior surface of the box blank 100. In some embodiments, the tear strip 170 may be formed by creating a pair of parallel perforation lines in the material of the box blank 100, defining a removable strip of material therebetween. In some embodiments, the tear strip 170 may include a combination of added material and perforations. In some embodiments, the tear strip 170 is positioned such that when pulled, the tear strip 170 separates the extension portion from the adjacent panel area, thereby releasing the adhesive seal and allowing the box to be opened. In some embodiments, the tear strip 170 may extend along the full length of the extension portion score line 136a or 136b, or along only a portion thereof. In some embodiments, the tear strip 170 may have a width sufficient to provide a user with adequate grip for pulling the tear strip 170 from the box.

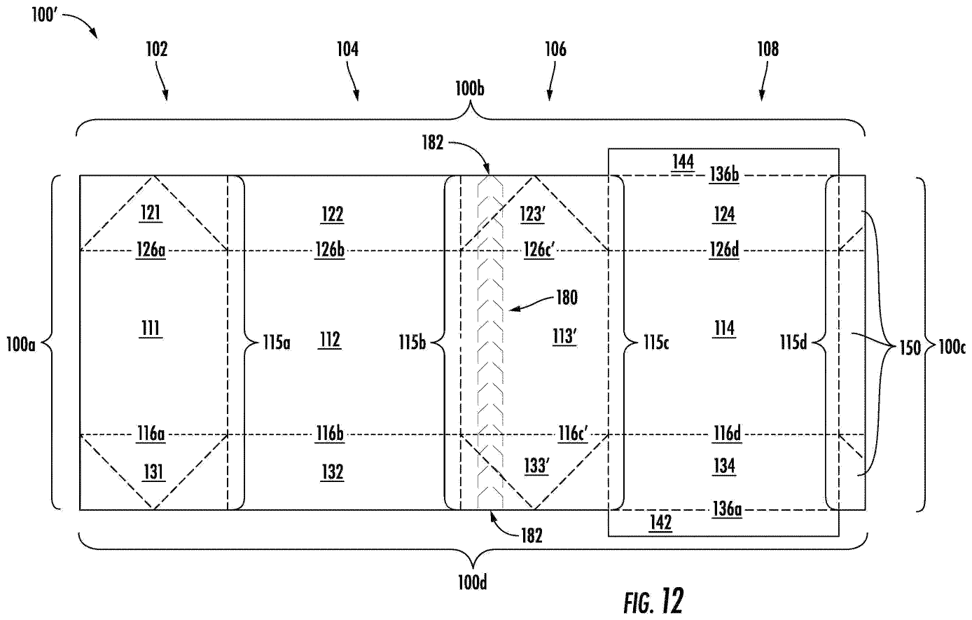

In some embodiments, as illustrated in FIG. 12, a box blank 100′ may include a teardown feature disposed on, and substantially extending vertically through, the first section, the second section, the third section or the fourth section of the box blank. In an embodiment, once the box is assembled into a formed box 200′, the teardown feature enables the breakdown of the assembled box 200′. In some embodiments, the teardown feature includes a tear strip 180 comprising pre-scored weakened sections extending vertically along the first section, the second section, the third section or the fourth section of the box blank 100′. In some embodiments, the teardown feature further includes a pull tab 182 located at one end of the tear strip 180. In some embodiments, the teardown feature includes a pull tab 182 located at both ends of the tear strip 180.

In some embodiments, the pull tab 182 allows a user to grip a first end portion of the tear strip 180 and be able to pull the tear strip 180 from the box 200′. In some embodiments, as the tear strip 180 is pulled, it engages the consecutive pre-scored weakened sections of the tear strip 180, causing the box 200′ to tear along the weakened lines. As the tear strip 180 is pulled further, the box 200′ is progressively dismantled, flattening the box 200′ into a compact, easy-to-dispose shape. In some embodiments, the tear strip 180 effectively reduces the need for external tools like knives or scissors, making the process of breaking down the box 200′ fast and efficient.

In some embodiments, the tear strip 180 may be an added material attached or bonded to the box blank 100′ or may be formed using perforations in the existing material of the box blank 100′. In some embodiments, the tear strip 180 may comprise a strip of material, such as a paper-based strip, a plastic strip, a fiber-reinforced strip, or a combination thereof, that is adhered to the exterior or interior surface of the box blank 100′. In some embodiments, the tear strip 180 may be formed by creating a pair of parallel perforation lines in the material of the box blank 100′, defining a removable strip of material therebetween. In some embodiments, the tear strip 180 may include a combination of added material and perforations. In some embodiments, the pull tab 182 may be a portion of the tear strip 180 that extends beyond the second outer edge 100b or the fourth outer edge 100d of the box blank 100′, providing a gripping surface for a user to initiate the tearing action. In some embodiments, the pull tab 182 may be a separate element attached to the tear strip 180. In some embodiments, the tear strip 180 may be positioned at various locations along the width of the first section 102, the second section 104, the third section 106, or the fourth section 108, depending on the desired teardown path and the location of pattern scores within the section.

In some embodiments, as illustrated in FIG. 12, a modified box blank 100′ may include a first section 102 comprising a first body panel 111, a first bottom panel 131 connected along a first portion 116a of a first panel score line 116, and a first top panel 121 connected to the first body panel 111 along a first portion 126a of a second panel score line 126. In an embodiment, the box blank 100′ may further include a second section 104 comprising a second body panel 112, a second bottom panel 132 connected along a second portion 116b of the first panel score line 116, and a second top panel 122 connected to the second body panel 112 along a second portion 126b of the second panel score line 126, in which the first section 102 and the second section 104 are connected along a first section score line 115a. In an embodiment, the box blank 100′ may further include a third section 106 comprising a third body panel 113, a third bottom panel 133 connected along a third portion 116c of the first panel score line 116, and a third top panel 123 connected to the third body panel 113 along a third portion 126c of the second panel score line 126, in which the second section 104 and the third section 106 are connected along a second section score line 115b. In an embodiment, the box blank may further include a fourth section 108 comprising a fourth body panel 114, a fourth bottom panel 134 connected along a fourth portion 116d of the first panel score line 116, and a fourth top panel 124 connected to the fourth body panel 114 along a fourth portion 126d of the second panel score line 126, in which the third section 106 and the fourth section 108 are connected along a third section score line 115c.

In an embodiment, the modified box blank 100′ may further include a glue flap 150 comprising at least a first glue flap panel connected to either the first section 102 or the fourth section 108 along a fourth section score line 115d. In some embodiments, each portion of the first panel score line 116, the first section score line 115a, the second section score line 115b, the third section score line 115c and the fourth section score line 115d may be foldable. In some embodiments, each portion of the first panel score line 116, the first section score line 115a, the second section score line 115b, the third section score line 115c and the fourth section score line 115d may include scoring such that each section score line may be folded by a user. In an embodiment, as will be discussed in greater detail below, the teardown feature may be disposed on, and substantially extending vertically through, the first section 102, the second section 104, the third section 106 or the fourth section 108 of the box blank 100′.

In an embodiment, a first pattern score may be positioned along the first bottom panel 131, the first pattern score having one or more score lines 135a, 135b separating the first bottom panel 131 into at least three sections 131a, 131b, 131c (see FIG. 3). In an embodiment, a second pattern score may be positioned along the third bottom panel 133, the second pattern score having one or more score lines 135c, 135d separating the third bottom panel 133 into at least three sections 133a, 133b, 133c (see FIG. 3). In an embodiment, a third pattern score may be positioned along the first top panel 121, the third pattern score having one or more score lines 125a, 125b separating the first top panel 121 into at least three sections 121a, 121b, 121c (see FIG. 3). In an embodiment, a fourth pattern score may be positioned on the third top panel 123, the fourth pattern score having one or more score lines 125c, 125d separating the third top panel 123 into at least three sections 123a, 123b, 123c (see FIG. 3).

In some embodiments, as also discussed above, the box blank 100′ may be configured to be assembled into a formed box 200′ when the glue flap 150 is connected to either the first section 102 or the fourth section 108 along the fourth section score line 115d. In some embodiments, when the box blank 100′ is assembled into the formed box 200′, the first pattern score and the second pattern score enable folding such that the first bottom panel 131 may fold towards the third bottom panel 133. In some embodiments, the folding further enables the second bottom panel 132 and the fourth bottom panel 134 to fold on top of the first bottom panel 131 and the third bottom panel 133 to form a bottom portion of the formed box 200′. In some embodiments, when the box blank is assembled into the formed box 200′, the third pattern score and the fourth pattern score enable folding such that the first top panel 121 folds towards the third top panel 123. In some embodiments, the folding further enables the second top panel 122 and the fourth top panel 124 to fold on top of the first top panel 121 and the third top panel 123 to form a top portion of the formed box 200′.

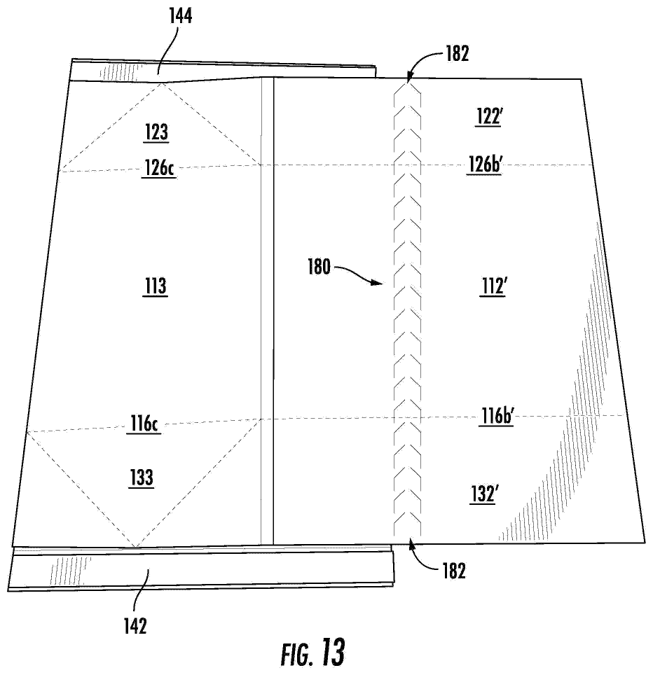

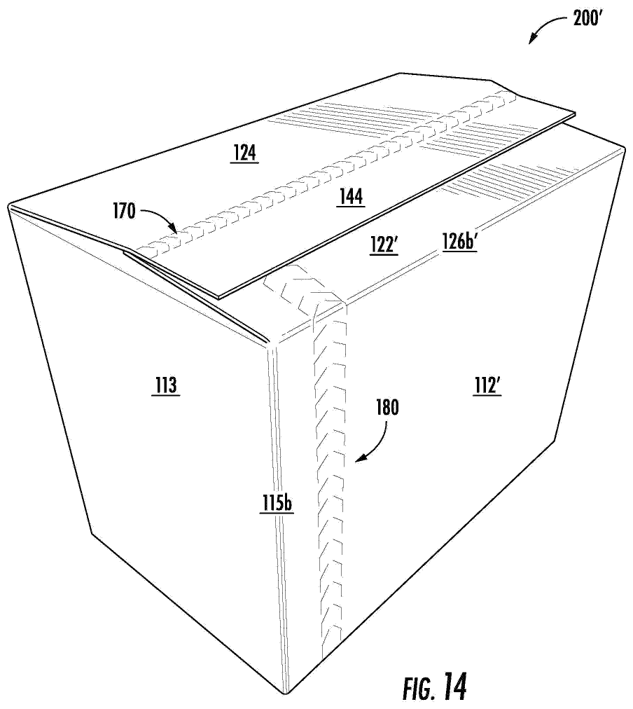

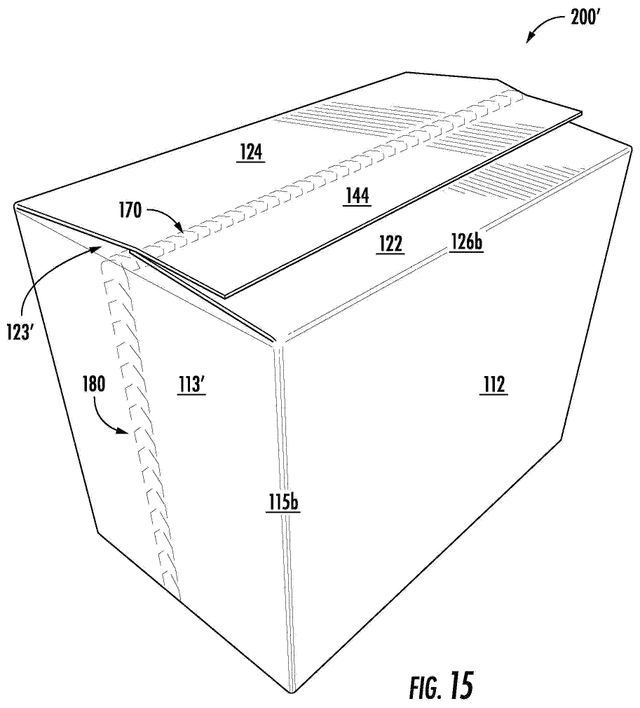

In some embodiments, the box blank 100′ may comprise a first outer edge 100a, a second outer edge 100b, a third outer edge 100c, and a fourth outer edge 100d, defining an outer periphery of the box blank 100′. In some embodiments, the teardown feature may extend between the second outer edge 100b and the fourth outer edge 100d of the box blank 100′. In some embodiments, the teardown feature may extend vertically through the first top panel 121, the first body panel 111 and the first bottom panel 131. In some embodiments, the teardown feature may extend vertically through the second top panel 122, the second body panel 112 and the second bottom panel 132, as shown in FIGS. 13 and 14. In some embodiments, the teardown feature may extend vertically through the third top panel 123, the third body panel 113 and the third bottom panel 133, as illustrated in FIGS. 12 and 15. In some embodiments, the teardown feature may extend vertically through the fourth top panel 124, the fourth body panel 114 and the fourth bottom panel 134.

In some embodiments, the teardown feature, and specifically the tear strip 180, aids in the breakdown of the formed box 200′. In some embodiments, the tear strip 180 may comprise of pre-scored weakened sections along the first section 102, the second section 104, the third section 106 or the fourth section 108 of the box blank 100′. In some embodiments, the teardown feature may include the tear strip 180, hook and loop fasteners, removable stitching (such as a locking chain stitch), a single-thread chain stitch, a double-thread chain stitch, or any similar features designed for easy removal from the box 200′. Furthermore, while FIGS. 12-15 show a double zipper perforation configuration for the tear strip 180 of the teardown feature, any tear strip configuration known in the art may be used, including but not limited to, a single zipper perforation, dashed perforations, dot perforations, press and lift perforations, rip tab perforations, among others. In some embodiments, the perforations of the tear strip 180 may be evenly spaced with respect to each other while in some embodiment one or more perforations of the tear strip 180 may be staggered and/or unevenly spaced.

In some embodiments, the tear strip 180 may be positioned on and extend through any suitable location on the first section 102, the second section 104, the third section 106 or the fourth section 108 that allows a user to pull the tear strip 180 from the box 200′ and break down the box 200′. In some embodiments, the teardown feature may extend vertically through the first top panel 121, the first body panel 111 and the first bottom panel 131. In some embodiments, as illustrated in FIG. 12, the teardown feature may extend vertically through the third top panel 123, the third body panel 113 and the third bottom panel 133. In some embodiments, when the teardown feature is positioned on the first section 102 or the third section 106, the tear strip 180 may not be positioned on and extend through the middle of the first section 102 or the third section 106. In some embodiments, due to the third pattern score having one or more score lines 125a, 125b and the fourth pattern score having one or more score lines 125c, 125d, both of which intersect at the center of the first section 102 and third section 106, the tear strip 180 may instead be placed in an offset position (e.g., to the left side of the center of the first section 102 and the third section 106 (as shown in FIG. 12) or to the right side of the center of the first section 102 and the third section 106) and proximate the first section score line 115a, the second section score line 115b, the third section score line 115c, or the fourth section score line 115d, so as to not coincide and overlap with the one or more score lines.

In some embodiments, FIG. 13 illustrates a tubular knocked-down box of another example box blank in which the teardown feature may extend vertically through the second top panel 122, the second body panel 112 and the second bottom panel 132. In some embodiments, FIG. 14 illustrates an example assembled box 200′ having the teardown feature extend vertically through the second top panel 122, the second body panel 112 and the second bottom panel 132 of the assembled box 200′ to aid in breaking down of the assembled box 200′. In some embodiments, FIG. 15 illustrates an example assembled box 200′ having the teardown feature extend vertically through the third top panel 123, the third body panel 113 and the third bottom panel 133 on the assembled box 200′ to aid in breaking down of the assembled box 200′. In some embodiments, when the teardown feature is positioned on the second section 104 or the fourth section 108, the teardown feature may be positioned at the center (e.g., middle of the section) since the second section 104 or the fourth section 108 does not include one or more score lines.

In some embodiments, as illustrated in FIGS. 14 and 15, the formed box 200′ may include both a tear strip 170 and a tear strip 180. The tear strip 170 may be an opening feature positioned between one or more of the extension portions 142, 144 and an adjacent panel, and the tear strip 180 may be a teardown feature extending vertically through one of the sections of the box blank 100′. In some embodiments, the tear strip 170 and the tear strip 180 may be two distinct features that serve different functions. In some embodiments, the tear strip 170 may enable a user to open the formed box 200′ by separating the extension portion from the adjacent panel area, thereby releasing the adhesive seal and providing access to the contents of the formed box 200′ without the need for external tools. In some embodiments, the tear strip 180 may enable a user to break down the formed box 200′ by pulling the pull tab 182 to engage the pre-scored weakened sections, progressively dismantling the formed box 200′ into a flattened structure for disposal. In some embodiments, a user may first use the tear strip 170 to open the formed box 200′ and access the contents therein, and subsequently use the tear strip 180 to break down the formed box 200′ for disposal. In some embodiments, the formed box 200′ may include only the tear strip 170 without the tear strip 180. In some embodiments, the formed box 200′ may include only the tear strip 180 without the tear strip 170. In some embodiments, the formed box 200′ may include both the tear strip 170 and the tear strip 180, providing the user with the ability to both open and break down the formed box 200′ without the need for external tools.

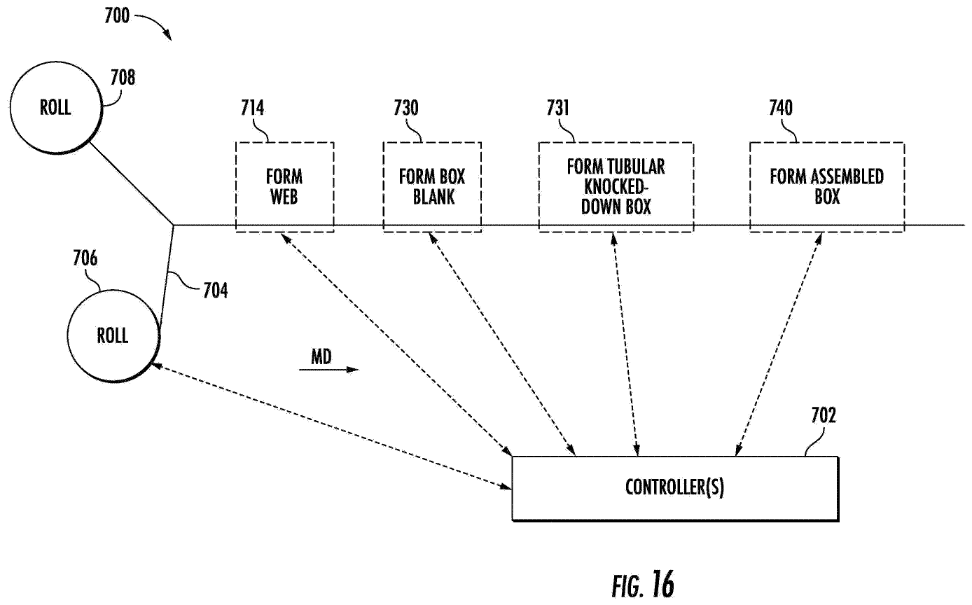

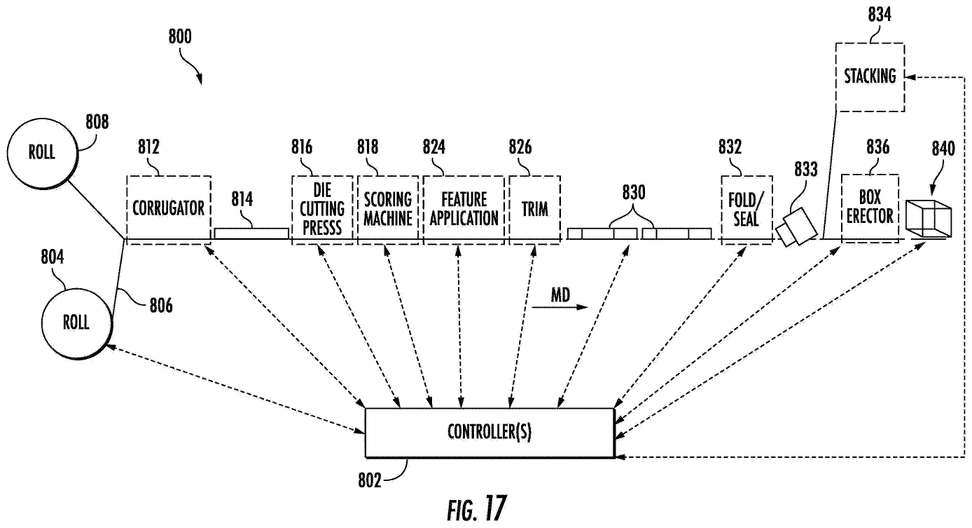

FIG. 16 shows a schematic representation of a system 700 for forming a box. The system 700 may, such as through controller 702, cause conveyance of one or more corrugated webs, such as along the machine direction (MD) arrow. For example, one or more conveyor means (e.g., a conveyor belt, one or more rollers, etc.) and/or motors may be used to cause a roll 708 having a flat linerboard sheet to bind with a roll 706 having a flat linerboard sheet, that is formed into a corrugated medium having a wavy layer 704, e.g. flutes, to form a single-face corrugated web 714. To further explain, in some embodiments, the flat linerboard sheet of the roll 706 may be a corrugated medium that may pass through a preheater to soften and condition the sheet, making it pliable for shaping. In some embodiments, the flat linerboard sheet of the roll 706 may be then fed between two heated, toothed corrugating rollers forming the medium into a wave-like structure called flutes 704. In some embodiments, a thin layer of adhesive may then be applied to the tips of the flutes on one side of the corrugated medium which ensures a strong bond with the linerboard sheet of roll 708. In some embodiments, the linerboard sheet of roll 708 is then brought into contact and bonded to the adhesive-coated flutes 704 forming a single-face corrugated web 714. In some embodiments, the system 700 may further include another roll having a flat linerboard sheet that may bind to the opposite side of the flutes 704 to form a single wall corrugated web. After that, as will be discussed in greater detail in FIG. 17, the conveyor means may cause the web 714 to form into a box blank 730. In an embodiment, the box blank 730 includes perforations, scores, cuts and/or features to form a box. Once the box blank 730 is configured, the conveyor means may cause the box blank 730 to be folded and formed into a tubular knocked-down box 731. In one example, once the tubular knocked-down box 731 is formed, the conveyor means may cause the tubular knocked-down box 731 to be stacked for shipment. In other examples, the conveyor means may cause the tubular knocked-down box 731 to be formed into an assembled box 740.

FIG. 17 illustrates another schematic representation of a system 800 for forming a box. The system 800 may, such as through controller 802, cause conveyance of one or more corrugated webs, such as along the machine direction (MD) arrow. For example, as discussed above, one or more conveyor means (e.g., a conveyor belt, one or more rollers, etc.) and/or motors may be used to cause a roll 808 having a flat linerboard sheet to bind with a roll 804 having a flat linerboard sheet, that is formed into a corrugated medium having a wavy layer 806, e.g., flutes, to form a single-face corrugated web 814. In some embodiments, the system 800 may further include another roll having a flat linerboard sheet that may bind to the opposite side of the flutes 806 to form a single wall corrugated web. After that, the conveyor means may cause the single-face corrugated web 814 to pass through a die cutting phase 816, a scoring phase 818, a feature application phase 824, and a trim phase 826 to form a box blank 830. Subsequently, the box blank 830 may be folded in a folding phase 832 to form a knocked-down tubular box 833. Thereafter, the knocked-down tubular box 833 may either pass through a stacking phase 834 for stacking of the boxes 833 or pass through a box erecting phase 836 to form a formed assembled box 840. Notably, in conjunction with various embodiments described herein, various of the phases can be combined, changed in order of operation, separated, or otherwise changed. For example, in some embodiments, the web 814 may pass through the scoring phase 818 before the die cutting phase 816, and in some embodiments, the die cutting phase 816 and the scoring phase 818 may be combined into one phase of the system 800.

The controller 802 provides logic and control functionality used during operation of the system 800. In some embodiments, the functionality of the controller 802 may be distributed to several controllers that each provides more limited functionality to discrete portions of the operation of system 800. The controller 802 may comprise one or more suitable electronic device(s)/server(s) capable of executing described functionality via hardware and/or software control. In some embodiments, the controller 802 may include one or more user interfaces (not shown), such as for displaying information and/or accepting instructions. The controller 802 can be, but is not limited to, a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a solid-state computer, a single-board computer, a buffered computer, a computer network, a desktop computer, a laptop computer, a personal digital assistant (PDA) or a hybrid of any of the foregoing.

The controller 802 may include one or more processors coupled to a memory device. Controller 802 may optionally be connected to one or more input/output (I/O) controllers or data interface devices (not shown). The memory may be any suitable form of memory such as an EPROM (Erasable Programmable Read Only Memory) chip, a flash memory chip, a disk drive, or the like. As such, the memory may store various data, protocols, instructions, computer program code, operational parameters, etc. In this regard, the controller 802 may include operation control methods embodied in application code. These methods are embodied in computer instructions written to be executed by one or more processors, typically in the form of software. The software can be encoded in any suitable language, including, but not limited to, machine language, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software. In this regard, in some embodiments, the controller 802 may be configured to execute computer program code instructions to perform aspects of various embodiments of the present invention described herein.

The controller 802 may be operably coupled with one or more components of the system 800, including for example, the roll 804, the sheet of flat linerboard 808, various components of the corrugation phase 812, various components of the die cutting phase 816, various components of the scoring phase 818, various components of the feature application phase 824, various components of the trim phase 826, various components of the folding phase 832, various components of the stacking phase 834, and various components of the box erecting phase 836 and other components (such as described herein). For example, depending on the components, the controller 802 may be operably coupled such as through use of solid-core wiring, twisted pair wiring, coaxial cable, fiber optic cable, mechanical, electrical, wireless, radio, infrared, etc. In this regard, depending on the components, the operable coupling may be through one or more intermediate controllers or mechanical coupling, such as used for controlling some components. In some embodiments, the controller 802 may be configured to provide one or more operating signals to these components and to receive data from these components.

During the corrugation phase 812, the controller 802 may be configured to cause a linerboard sheet of roll 808 and a linerboard sheet of roll 804 to go through a corrugator machine. In some embodiments, the corrugator machine may cause the flat linerboard sheet of roll 808 to bind with a corrugated medium that may be created from a linerboard sheet of roll 804. In some embodiments, the corrugator may cause the flat linerboard sheet of the roll 804 to pass through a preheater to soften and condition the sheet, making it pliable for shaping. In some embodiments, the flat linerboard sheet of the roll 804 may be then fed between two heated, toothed corrugating rollers forming the sheet into a wave-like structure called flutes. In some embodiments, a thin layer of adhesive may then be applied to the tips of the flutes on one side of the corrugated medium which ensures a strong bond with the linerboard sheet of roll 808. In some embodiments, the linerboard sheet of roll 808 is then brought into contact and bonded to the adhesive-coated flutes forming a single-face corrugated web 814.

During the die cutting phase 816, the single-face corrugated web 814 may be positioned on a die cutting press to cut, shape, or crease the corrugated web 814 into specific designs and dimensions, creating custom box shapes or features. In an embodiment, the machine may use a die, which is a customized tool with sharp blades or scoring rules arranged in the desired shape or pattern of the box. The die is pressed onto the corrugated web 814, cutting through the material to form edges and shapes, and creasing where folds are needed. In an embodiment, the single-face corrugated web 814 is a continuous piece of material having no cuts between adjacent panels of the sheet 814. Thus, in some embodiments, the machine makes no cuts, e.g., no cut-outs, through-cuts, or intentional cuts or openings between the panels within the outer periphery of the sheet 814 but rather only weaknesses, creasing, scoring, small perforations, or the like such that each score line, and therefore each panel, may be foldable by the user to create a formed box 840.

During the scoring phase 818, a scoring machine may further create crease lines on the corrugated sheet 814 to make it easier to fold along precise lines without cracking or damaging the corrugated sheet 814. In an embodiment, the machine uses wheels or blunt blades to press a controlled indentation into the material along a straight line. The scoring process does not cut through the material; instead, it weakens the top layer, allowing for clean, precise folds. In an embodiment, the scoring machine is used to create the pattern scores positioned along the first bottom panel and the third bottom panel of the box.

During the feature application phase 824, the controller 802 may be configured to cause application of one or more features to the corrugated web 814. For example, with reference to FIG. 6, a strip of adhesive and a corresponding pull-strip for revealing the strip of adhesive can be applied. As another example, with reference to FIG. 10A, a tear strip can be applied. Other features or additions to the corrugated web 814 are also contemplated.

During the trim phase 826, the controller 802 may be configured to cause a machine to cut out the corrugated sheet 814 (which are still connected along their lengths since their layers are in web form) to create a box blank 830. In this regard, the controller 802 may be operably coupled to the various knives to control operation during the trim phase 826.

During the folding phase 832, the controller 802 may be configured to operate one or more machines to fold the box blank 830 along pre-scored lines on the box blank 830 and also seal portions of the box blank 830 to create a knocked-down tubular box 833. For example, with reference to FIGS. 2B, 4A-4B, the controller 802 may be configured to operate one or more machines to fold the box blank 830 so to connect the glue flap 150 to either the first section 102 or the fourth section 108 along the fourth section score line 115d and then seal the glue flap to the receiving portion to create a tubular knocked down box 833.

After a tubular knocked down box 833 is created, the box 833 may either proceed to a stacking phase 834 for storage and transportation or the box 833 may proceed to a box erecting phase 836 to form an assembled (e.g., assembled, constructed, ready-to-use) box 840. During the stacking phase 834, the controller 802 may be configured to operate one or more machines to organize flat, unassembled boxes for efficient storage and transportation. After the folding phase 832, the tubular knocked down box 833 may remain in a flat, knocked-down position, minimizing their volume. The tubular knocked down box 833 may be aligned and stacked on top of each other in uniform piles to ensure stability. Straps, shrink wrap, or bands are applied to hold the stack tightly together, preventing movement or damage during storage or shipment.

During the box erecting phase 836, the controller 802 may be configured to operate one or more machines to form an assembled box 840 from the tubular knocked down box 833. For example, the controller 802 may be configured to operate one or more machines to cause the first pattern score and the second pattern score to fold in a way that folds the plurality of bottom panels into a bottom portion of the formed box 840. During the box erecting phase 836, the controller 802 may also be configured to operate one or more machines to seal the plurality of extension portions to a receiving portion of the top and/or bottom panels, thus securing the box 840 in a closed configuration.

### Example Flowchart(s)

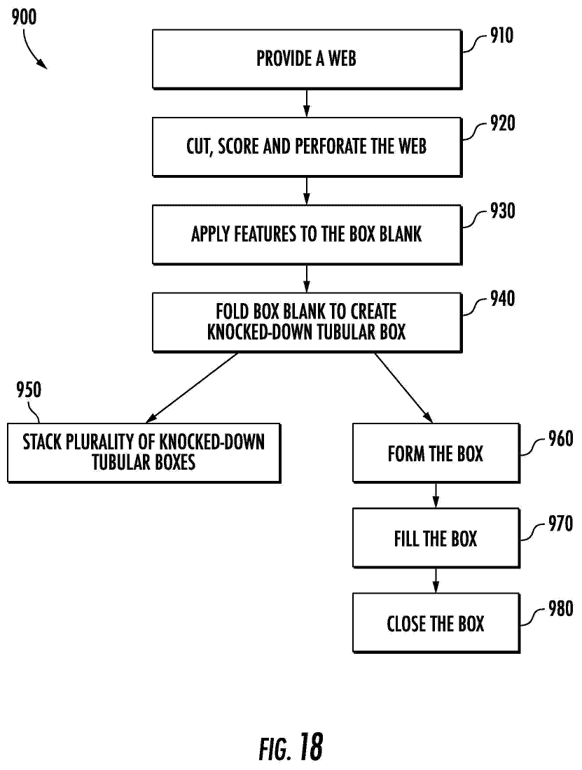

Various examples of the operations performed in accordance with some embodiments of the present invention will now be provided with reference to FIG. 18. In this regard, FIG. 18 illustrates a flowchart according to an example method for forming a box from a box blank according to an example embodiment 900. The operations illustrated in and described with respect to FIG. 18 may, for example, be performed by, with the assistance of, and/or under the control of one or more of a user or a machine for performing the operation (e.g., a corrugator for forming the corrugated box blanks, a die cut for scoring and cutting the corrugated box blanks, a box maker for forming the box or portions thereof, etc.).

Operation 910 may comprise providing a web, in which the web is a single-face corrugated board, composed of one layer of flat linerboard bonded to a single layer of corrugated medium. Operation 920 may comprise running the web through a die cutting press to form the box blank with appropriate scores, perforations and cuts, such as described herein.

Operation 930 may comprise running the box blank through other machines to apply additional features to the box blank, such as adhesives as described herein. Operation may comprise providing the box blank to a box maker to fold the box blank into a knocked-down tubular box. Operation 950 may comprise providing the knocked-down tubular box to a stacking machine to stack and bundle a plurality of knocked-down boxes.

Operation 960 may comprise forming an assembled box from the tubular knocked down box. Operation 970 may comprise filling the box with one or more desired items. Operation 980 may comprise closing the box.

Selected embodiments follow:

### Example 1

A method of forming a box blank, the method comprising:
providing a web made from a single-face corrugated material having a plurality of flutes positioned on one side of the web;
running the web through a die cutting press to form the box blank, wherein forming the box blank includes:
   forming a first section comprising at least a first body panel and a first bottom panel connected along a first portion of a first panel score line;
   forming a second section comprising at least a second body panel and a second bottom panel connected along a second portion of the first panel score line, wherein the first section and the second section are connected along a first section score line, wherein one or more extension portions extend from the second bottom panel along an extension portion score line, wherein the one or more extension portions include adhesive material to aid in closing and sealing the formed box;
   forming a third section comprising at least a third body panel and a third bottom panel connected along a third portion of the first panel score line, wherein the second section and the third section are connected along a second section score line;
   forming a fourth section comprising at least a fourth body panel and a fourth bottom panel connected along a fourth portion of the first panel score line, wherein the third section and the fourth section are connected along a third section score line;
   forming a glue flap comprising at least a first glue flap panel connected to either the first section or the fourth section along a fourth section score line;
   wherein the box blank is configured to be assembled into a formed box when the glue flap is connected to either the first section or the fourth section along the fourth section score line;
   forming a first pattern score positioned along the first bottom panel, the first pattern score having one or more score lines separating the first bottom panel into at least three sections;
   forming a second pattern score positioned along the third bottom panel, the second pattern score having one or more score lines separating the third bottom panel into at least three sections;
   cutting out the box blank to include a first outer edge, a second outer edge, a third outer edge, and a fourth outer edge defining an outer periphery of the box blank; and
providing the box blank to a box maker to assemble a formed box.

### Example 2

The method of example 1, wherein forming the box blank further includes crushing the box blank along the one or more score lines to aid in folding of the panels.

### Example 3

The method of example 2, wherein forming the box blank further includes attaching the one or more extension portions to the fourth bottom panel to form a closed portion of the box.

### Example 4

A box blank for a box, the box blank comprising:
a first section comprising at least a first body panel, a first bottom panel connected along a first portion of a first panel score line, and a first top panel connected to the first body panel along a first portion of a second panel score line;
a second section comprising at least a second body panel, a second bottom panel connected along a second portion of the first panel score line, and a second top panel connected to the second body panel along a second portion of the second panel score line, wherein the first section and the second section are connected along a first section score line;
a third section comprising at least a third body panel, a third bottom panel connected along a third portion of the first panel score line, and a third top panel connected to the third body panel along a third portion of the second panel score line, wherein the second section and the third section are connected along a second section score line;
a fourth section comprising at least a fourth body panel, a fourth bottom panel connected along a fourth portion of the first panel score line, and a fourth top panel connected to the fourth body panel along a fourth portion of the second panel score line, wherein the third section and the fourth section are connected along a third section score line;
a glue flap comprising at least a first glue flap panel connected to either the first section or the fourth section along a fourth section score line;
wherein each portion of the first panel score line, each portion of the second panel score line, the first section score line, the second section score line, the third section score line and the fourth section score line are foldable;
a teardown feature disposed on, and substantially extending vertically through, the first section, the second section, the third section or the fourth section of the box blank;
a first pattern score positioned along the first bottom panel, the first pattern score having one or more score lines separating the first bottom panel into at least three sections;
a second pattern score positioned along the third bottom panel, the second pattern score having one or more score lines separating the third bottom panel into at least three sections;
a third pattern score positioned along the first top panel, the third pattern score having one or more score lines separating the first top panel into at least three sections;
a fourth pattern score positioned along the third top panel, the fourth pattern score having one or more score lines separating the third top panel into at least three sections;
wherein the box blank is configured to be assembled into a formed box when the glue flap is connected to either the first section or the fourth section along the fourth section score line;
wherein, when the box blank is assembled into the formed box, the first pattern score and the second pattern score enable folding such that the first bottom panel folds towards the third bottom panel, and wherein the folding enables the second bottom panel and the fourth bottom panel to fold on top of the first bottom panel and the third bottom panel to form a bottom portion of the formed box;
wherein, when the box blank is assembled into the formed box, the third pattern score and the fourth pattern score enable folding such that the first top panel folds towards the third top panel, and wherein the folding enables the second top panel and the fourth top panel to fold on top of the first top panel and the third top panel to form a top portion of the formed box; and
wherein once the box is assembled, the teardown feature enables the breaking down of the formed box.

### Example 5

The box blank of example 4, wherein the teardown feature extends through the first top panel, the first body panel and the first bottom panel.

### Example 6

The box blank of example 4, wherein the teardown feature extends through the second top panel, the second body panel and the second bottom panel.

### Example 7

The box blank of example 4, wherein the teardown feature extends through the third top panel, the third body panel and the third bottom panel.

### Example 8

The box blank of example 4, wherein the teardown feature extends through the fourth top panel, the fourth body panel and the fourth bottom panel.

### Example 9

The box blank of example 4, wherein the teardown feature includes a tear strip comprising pre-scored weakened sections extending vertically along the first section, the second section, the third section or the fourth section of the box blank, and wherein the teardown feature includes a pull tab located at one end of the tear strip.

### Example 10

The box blank of example 9, wherein pulling the tab from the formed box engages the tear strip to cut through the first section, the second section, the third section or the fourth section of the formed box along the pre-scored weakened sections of the tear strip, enabling the breakdown of the formed box.

### Example 11

The box blank of example 9, wherein once the tear strip is pulled from the box, the box assumes a flattened structure to aid in disposal.

### Example 12

The box blank of example 4, wherein adjacent panels of the box blank are not separated from each other.

### Example 13

The box blank of example 4, wherein the box includes a first outer edge, a second outer edge, a third outer edge, and a fourth outer edge defining an outer periphery of the box blank, and wherein there are no cuts between adjacent panels of the box blank.

### Example 14

The box blank of example 4, wherein the one or more score lines include two diagonal score lines, and wherein the one or more score lines are configured to create at least a first triangular-shaped section, a second triangular-shaped section and a third triangular-shaped section along each of the first bottom panel and the third bottom panel.

### Example 15

The box blank of example 4, wherein when the box blank is assembled into the formed box:
the first pattern score and the second pattern score enable folding such that the second triangular-shaped section is folded first;
the first triangular-shaped section and the third triangular-shaped section fold over the second triangular-shaped section; and
the first triangular-shaped section and the third triangular-shaped section cause the second bottom panel and the fourth bottom panel to fold on top of the first bottom panel and the third bottom panel to form the bottom portion of the formed box.

### Example 16

The box blank of example 4, further comprising at least two extension portions connected to the second top panel and the second bottom panel of the second section or the fourth top panel and the fourth bottom panel of the fourth section.

### Example 17

The box blank of example 16, wherein a first extension portion of the at least two extension portions and the second or the fourth bottom panel are connected along a first extension portion score line, and wherein a second extension portion of the at least two extension portions and the second or the fourth top panel are connected along a second extension portion score line.

### Example 18

The box blank of example 16, wherein each of the at least two extension portions include adhesive material to aid in assembling the box.

### Example 19

The box blank of example 16, further comprising one or more tear strips positioned between one or more of the extension portions and the second top panel of the second section, the second bottom panel of the second section, the fourth top panel of the fourth section or the fourth bottom panel of the fourth section.

### Example 20

The box blank of example 4, wherein the length of each panel of the second section and the fourth section is greater than the length of each panel of the first section and the third section.

### Example 21

The box blank of example 4, wherein the box blank is formed into the box without the use of external tools.

### Example 22

The box blank of example 4, wherein the box blank is dismantled into the flat structure without the use of external tools.

### Example 23

The box blank of example 4, wherein the box is a single-face corrugated box, and wherein the box includes a plurality of flutes positioned on an interior surface of the box perpendicular to the first, the second, the third, and the fourth section score lines and parallel to the first and the second panel score lines.

### Example 24

A box blank for a box, the box blank comprising:
a first section comprising at least a first body panel and a first bottom panel connected along a first portion of a first panel score line;
a second section comprising at least a second body panel and a second bottom panel connected along a second portion of the first panel score line, wherein the first section and the second section are connected along a first section score line;
a third section comprising at least a third body panel and a third bottom panel connected along a third portion of the first panel score line, wherein the second section and the third section are connected along a second section score line;
a fourth section comprising at least a fourth body panel and a fourth bottom panel connected along a fourth portion of the first panel score line, wherein the third section and the fourth section are connected along a third section score line;
a glue flap comprising at least a first glue flap panel connected to either the first section or the fourth section along a fourth section score line;
wherein each portion of the first panel score line, the first section score line, the second section score line, the third section score line and the fourth section score line is foldable;
a teardown feature disposed on, and substantially extending vertically through, the first section, the second section, the third section or the fourth section of the box blank;
a first pattern score positioned along the first bottom panel, the first pattern score having one or more score lines separating the first bottom panel into at least three sections;
a second pattern score positioned along the third bottom panel, the second pattern score having one or more score lines separating the third bottom panel into at least three sections;
wherein the first bottom panel with the first pattern score is pre-crushed to aid in folding of the first bottom panel, and wherein the third bottom panel with the second pattern score is pre-crushed to aid in folding of the third bottom panel;
wherein the box blank is configured to be assembled into a formed box when the glue flap is connected to either the first section or the fourth section along the fourth section score line;
wherein, when the box blank is assembled into the formed box, the first pattern score and the second pattern score enable folding such that the first bottom panel folds towards the third bottom panel, and wherein the folding enables the second bottom panel and the fourth bottom panel to fold on top of the first bottom panel and the third bottom panel to form a bottom portion of the formed box; and
wherein once the box is assembled, the teardown feature enables the breaking down of the formed box.

### Example 25

A method of forming a box, the method comprising:
providing a blank made from a single-face corrugated material having a plurality of flutes positioned on one side of the blank, the blank comprising:
   a first section comprising at least a first body panel and a first bottom panel connected along a first portion of a first panel score line;
   a second section comprising at least a second body panel and a second bottom panel connected along a second portion of the first panel score line, wherein the first section and the second section are connected along a first section score line;
   a third section comprising at least a third body panel and a third bottom panel connected along a third portion of the first panel score line, wherein the second section and the third section are connected along a second section score line;
   a fourth section comprising at least a fourth body panel and a fourth bottom panel connected along a fourth portion of the first panel score line, wherein the third section and the fourth section are connected along a third section score line;
   a glue flap comprising at least a first glue flap panel connected to either the first section or the fourth section along a fourth section score line;
   wherein the plurality of flutes each define a longitudinal axis that extends perpendicularly to the first section score line, the second section score line, the third section score line, and the fourth section score line and parallel to the first panel score line;
   wherein each portion of the first panel score line, the first section score line, the second section score line, the third section score line and the fourth section score line is foldable;
   a teardown feature disposed on, and substantially extending vertically through, the first section, the second section, the third section or the fourth section of the box blank;
   a first pattern score positioned along the first bottom panel, the first pattern score having one or more score lines separating the first bottom panel into at least three sections; and
   a second pattern score positioned along the third bottom panel, the second pattern score having one or more score lines separating the third bottom panel into at least three sections; and
adhering the glue flap to the first section or to the fourth section to form a four walled structure;
wherein, when the box blank is assembled into the formed box, the first pattern score and the second pattern score enable folding such that the first bottom panel folds towards the third bottom panel, and wherein the folding enables the second bottom panel and the fourth bottom panel to fold on top of the first bottom panel and the third bottom panel to form a bottom portion of the formed box; and
wherein once the box is assembled, the teardown feature enables the breaking down of the formed box.

### CONCLUSION

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A box blank for a box, the box blank comprising:
a first section comprising at least a first body panel and a first bottom panel connected along a first portion of a first panel score line;
a second section comprising at least a second body panel and a second bottom panel connected along a second portion of the first panel score line, wherein the first section and the second section are connected along a first section score line;
a third section comprising at least a third body panel and a third bottom panel connected along a third portion of the first panel score line, wherein the second section and the third section are connected along a second section score line;
a fourth section comprising at least a fourth body panel and a fourth bottom panel connected along a fourth portion of the first panel score line, wherein the third section and the fourth section are connected along a third section score line;
a glue flap comprising at least a first glue flap panel connected to either the first section or the fourth section along a fourth section score line;
wherein each portion of the first panel score line, the first section score line, the second section score line, the third section score line and the fourth section score line is foldable;
a first pattern score positioned along the first bottom panel, the first pattern score having one or more score lines separating the first bottom panel into at least three sections;
a second pattern score positioned along the third bottom panel, the second pattern score having one or more score lines separating the third bottom panel into at least three sections;
wherein the first bottom panel with the first pattern score is pre-crushed to aid in folding of the first bottom panel, and wherein the third bottom panel with the second pattern score is pre-crushed to aid in folding of the third bottom panel;
wherein the box blank is configured to be assembled into a formed box when the glue flap is connected to either the first section or the fourth section along the fourth section score line; and
wherein, when the box blank is assembled into the formed box, the first pattern score and the second pattern score enable folding such that the first bottom panel folds towards the third bottom panel, and wherein the folding enables the second bottom panel and the fourth bottom panel to fold on top of the first bottom panel and the third bottom panel to form a bottom portion of the formed box.

2. The box blank of claim 1, wherein:
the first section further comprises a first top panel connected to the first body panel along a first portion of a second panel score line;
the second section further comprises a second top panel connected to the second body panel along a second portion of the second panel score line, wherein the first top panel and the second top panel are also connected along the first section score line;
the third section further comprises a third top panel connected to the third body panel along a third portion of the second panel score line, wherein the second top panel and the third top panel are also connected along the second section score line;
the fourth section further comprises a fourth top panel connected to the fourth body panel along a fourth portion of the second panel score line, wherein the third top panel and the fourth top panel are also connected along the third section score line; and
each portion of the second panel score line is foldable.

3. The box blank of claim 2, wherein adjacent panels of the box blank are not separated from each other, wherein the box blank includes a first outer edge, a second outer edge, a third outer edge, and a fourth outer edge defining an outer periphery of the box blank, and wherein there are no cuts between adjacent panels of the box blank.

4. The box blank of claim 1, wherein the one or more score lines include two diagonal score lines, and wherein the one or more score lines are configured to create at least a first triangular-shaped section, a second triangular-shaped section and a third triangular-shaped section along each of the first bottom panel and the third bottom panel.

5. The box blank of claim 4, wherein when the box blank is assembled into the formed box:
the first pattern score and the second pattern score enable folding such that the second triangular-shaped section is folded first;
the first triangular-shaped section and the third triangular-shaped section fold over the second triangular-shaped section; and
the first triangular-shaped section and the third triangular-shaped section cause the second bottom panel and the fourth bottom panel to fold on top of the first bottom panel and the third bottom panel to form the bottom portion of the formed box.

6. The box blank of claim 2, further comprising at least two extension portions connected to the second top panel and the second bottom panel of the second section or the fourth top panel and the fourth bottom panel of the fourth section, wherein a first extension portion of the at least two extension portions and the second or the fourth bottom panel are connected along a first extension portion score line, wherein a second extension portion of the at least two extension portions and the second or the fourth top panel are connected along a second extension portion score line, and wherein each of the at least two extension portions include adhesive material to aid in assembling the box.

7. The box blank of claim 6, further comprising one or more tear strips comprising pre-scored weakened sections positioned between one or more of the extension portions and the second top panel of the second section, the second bottom panel of the second section, the fourth top panel of the fourth section or the fourth bottom panel of the fourth section.

8. The box blank of claim 2, wherein the box is a single-face corrugated box, and wherein the box includes a plurality of flutes positioned on an interior surface of the box perpendicular to the first, the second, the third, and the fourth section score lines and parallel to the first and the second panel score lines.

9. The box blank of claim 8, wherein placement of the plurality of flutes positioned on the first section and the fourth section of the box are offset by a distance from the plurality of flutes positioned on the second section and the third section of the box, and wherein the offset placement of the plurality of flutes allows the first section and the fourth section of the box to nest into the second section and the third section of the box when the box is in a flat knocked-down tubular form.

10. The box blank of claim 1, wherein the formed box includes one or more triangular protrusions positioned in an interior of the formed box created from the folding of the first pattern score and the second pattern score, wherein the one or more triangular protrusions aid in stabilizing an item placed inside the formed box, wherein the one or more triangular protrusions aid in protecting an item placed inside the formed box from damage, and wherein the one or more triangular protrusions aid in resistance of movement of an item placed inside the formed box.

11. The box blank of claim 8, wherein at least one of the first portion, the second portion, the third portion, or the fourth portion of the first panel score line includes one or more perforations, and wherein the one or more perforations aid in folding of the box blank along the first panel score line.

12. A box blank for a box, the box blank comprising:
a first section comprising at least a first body panel, a first bottom panel connected along a first portion of a first panel score line, and a first top panel connected to the first body panel along a first portion of a second panel score line;
a second section comprising at least a second body panel, a second bottom panel connected along a second portion of the first panel score line, and a second top panel connected to the second body panel along a second portion of the second panel score line, wherein the first section and the second section are connected along a first section score line;
a third section comprising at least a third body panel, a third bottom panel connected along a third portion of the first panel score line, and a third top panel connected to the third body panel along a third portion of the second panel score line, wherein the second section and the third section are connected along a second section score line;
a fourth section comprising at least a fourth body panel, a fourth bottom panel connected along a fourth portion of the first panel score line, and a fourth top panel connected to the fourth body panel along a fourth portion of the second panel score line, wherein the third section and the fourth section are connected along a third section score line;
a glue flap comprising at least a first glue flap panel connected to either the first section or the fourth section along a fourth section score line;
one or more extension portions connected to the second top panel, the second bottom panel, the fourth top panel or the fourth bottom panel of the box blank along an extension portion score line;
wherein each portion of the first panel score line, each portion of the second panel score line, the first section score line, the second section score line, the third section score line and the fourth section score line are foldable;
a first pattern score positioned along the first bottom panel, the first pattern score having one or more score lines separating the first bottom panel into at least three sections;
a second pattern score positioned along the third bottom panel, the second pattern score having one or more score lines separating the third bottom panel into at least three sections;
a third pattern score positioned along the first top panel, the third pattern score having one or more score lines separating the first top panel into at least three sections;
a fourth pattern score positioned along the third top panel, the fourth pattern score having one or more score lines separating the third top panel into at least three sections;
wherein the first bottom panel with the first pattern score is pre-crushed to aid in folding of the first bottom panel, wherein the third bottom panel with the second pattern score is pre-crushed to aid in folding of the third bottom panel, wherein the first top panel with the third pattern score is pre-crushed to aid in folding of the first top panel, and wherein the third top panel with the fourth pattern score is pre-crushed to aid in folding of the third top panel;
wherein the box blank is configured to be assembled into a formed box when the glue flap is connected to either the first section or the fourth section along the fourth section score line;
wherein, when the box blank is assembled into the formed box, the first pattern score and the second pattern score enable folding such that the first bottom panel folds towards the third bottom panel, and wherein the folding enables the second bottom panel and the fourth bottom panel to fold on top of the first bottom panel and the third bottom panel to form a bottom portion of the formed box;
wherein, when the box blank is assembled into the formed box, the third pattern score and the fourth pattern score enable folding such that the first top panel folds towards the third top panel, and wherein the folding enables the second top panel and the fourth top panel to fold on top of the first top panel and the third top panel to form a top portion of the formed box; and
wherein the one or more extension portions include adhesive material to aid in closing and sealing the formed box.

13. The box blank of claim 12, wherein at least one of the first panel score line or the second panel score line includes one or more perforations, and wherein the one or more perforations aid in folding of the box blank along at least one of the first panel score line or the second panel score line.

14. The box blank of claim 12, wherein the box is a single-face corrugated box, and wherein the box includes a plurality of flutes positioned on an interior surface of the box perpendicular to the first, the second, the third, and the fourth section score lines and parallel to the first and the second panel score lines.

15. The box blank of claim 12, further comprising a teardown feature disposed on, and substantially extending vertically through, the first section, the second section, the third section or the fourth section of the box blank, and wherein once the box is assembled, the teardown feature enables the breaking down of the formed box.

16. The box blank of claim 15, wherein the teardown feature includes a tear strip comprising pre-scored weakened sections extending vertically along the first section, the second section, the third section or the fourth section of the box blank, and wherein the teardown feature includes a pull tab located at one end of the tear strip.

17. The box blank of claim 16, wherein pulling the pull tab from the formed box engages the tear strip to cut through the first section, the second section, the third section or the fourth section of the formed box along the pre-scored weakened sections of the tear strip, enabling the breakdown of the formed box, and wherein once the tear strip is pulled from the box, the box assumes a flattened structure to aid in disposal.

18. A method of forming a box, the method comprising:
providing a blank made from a single-face corrugated material having a plurality of flutes positioned on one side of the blank, the blank comprising:
a first section comprising at least a first body panel and a first bottom panel connected along a first portion of a first panel score line;
a second section comprising at least a second body panel and a second bottom panel connected along a second portion of the first panel score line, wherein the first section and the second section are connected along a first section score line;
a third section comprising at least a third body panel and a third bottom panel connected along a third portion of the first panel score line, wherein the second section and the third section are connected along a second section score line;
a fourth section comprising at least a fourth body panel and a fourth bottom panel connected along a fourth portion of the first panel score line, wherein the third section and the fourth section are connected along a third section score line;
a glue flap comprising at least a first glue flap panel connected to either the first section or the fourth section along a fourth section score line;
wherein the plurality of flutes each define a longitudinal axis that extends perpendicularly to the first section score line, the second section score line, the third section score line, and the fourth section score line and parallel to the first panel score line;
wherein each portion of the first panel score line, the first section score line, the second section score line, the third section score line and the fourth section score line is foldable;
a first pattern score positioned along the first bottom panel, the first pattern score having one or more score lines separating the first bottom panel into at least three sections; and
a second pattern score positioned along the third bottom panel, the second pattern score having one or more score lines separating the third bottom panel into at least three sections; and
wherein the first bottom panel with the first pattern score is pre-crushed to aid in folding of the first bottom panel, and wherein the third bottom panel with the second pattern score is pre-crushed to aid in folding of the third bottom panel;
adhering the glue flap to the first section or to the fourth section to form a four walled structure;
wherein, when the box blank is assembled into the formed box, the first pattern score and the second pattern score enable folding such that the first bottom panel folds towards the third bottom panel, and wherein the folding enables the second bottom panel and the fourth bottom panel to fold on top of the first bottom panel and the third bottom panel to form a bottom portion of the formed box.

19. The method of claim 18, the blank further comprising at least one extension portion connected to the second bottom panel of the second section or the fourth bottom panel of the fourth section, wherein the at least one extension portion includes an adhesive material.

20. The method of claim 19, further comprising:
folding the first bottom panel towards a center of the four walled structure;
folding the third bottom panel towards the center of the four walled structure such that a portion of the first bottom panel is in face-to-face contact with a portion of the third bottom panel; and
causing adherence of the at least one extension portion to a receiving portion of the second bottom panel or the fourth bottom panel to assemble the formed box.
